(19) United States
(12) Patent Application Publication
(10) Pub. No.: US 2025/0306484 A1
(43) Pub. Date: Oct. 2, 2025

(54) ELECTROPHOTOGRAPHIC APPARATUS AND PROCESS CARTRIDGE

(71) Applicant: CANON KABUSHIKI KAISHA, Tokyo (JP)

(72) Inventor: YUKA ISHIDUKA, Shizuoka (JP)

(21) Appl. No.: 19/086,877

(22) Filed: Mar. 21, 2025

(30) Foreign Application Priority Data
Mar. 28, 2024 (JP) 2024-054287
Jan. 9, 2025 (JP) 2025-003592

(51) Int. Cl. G03G 9/08; G03G 5/147

(52) U.S. Cl. CPC G03G 9/0819; G03G 5/14704; G03G 5/14734; G03G 2215/00957; G03G 2215/00962; G03G 2215/0604; G03G 2221/183

(57) ABSTRACT

To provide an electrophotographic apparatus and a process cartridge each suppressing the occurrence of image smearing in an output image under a high-temperature and high-humidity environment, provided are the following electrophotographic apparatus and process cartridge. That is, provided are an electrophotographic apparatus including: an electrophotographic photosensitive member; a charging unit; an image exposing unit; a developing unit; and a transferring unit, wherein the electrophotographic photosensitive member includes a surface layer containing indium tin oxide particles and a (meth)acrylic resin, and wherein the toner contains strontium titanate particles as an external additive, and a process cartridge.

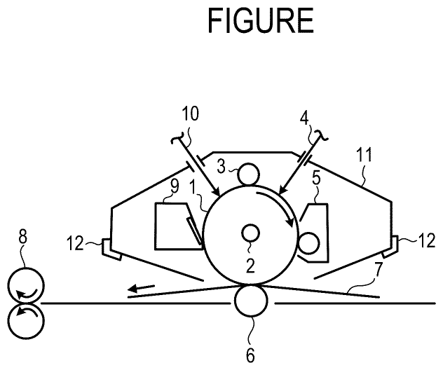

### BACKGROUND OF THE INVENTION

### Field of the Invention

The present disclosure relates to an electrophotographic apparatus and a process cartridge.

### Description of the Related Art

A wide variety of investigations have heretofore been made on an electrophotographic photosensitive member to be mounted on an electrophotographic apparatus or a process cartridge in order to improve its image quality and durability. As an example thereof, in U.S. Pat. No. 10,678,153, an investigation has been made on improving abrasion resistance (mechanical durability) through use of a polymerization product of a composition containing a (meth)acrylic radical polymerizable monomer and indium tin oxide particles serving as a filler in the surface of an electrophotographic photosensitive member (hereinafter sometimes referred to as “photosensitive member”). However, when the (meth)acrylic radical polymerizable monomer is used, a discharge product cannot be removed, though surface abrasion is suppressed. Thus, image smearing occurs. The image smearing as used herein refers to the following. Through the discharge, part of the polymerization product of the (meth)acrylic radical polymerizable monomer in the surface deteriorates, and high-polarity components each having a carboxy group are generated. Those components take in moisture, and hence the electric charge with which the surface is charged cannot be held in a predetermined place and flows, to thereby cause a problem in that a toner appears to have flowed on the image. On the side of the toner, in Japanese Patent Application Laid-Open No. 2022-34384, there is a proposal that a discharge product is scraped off by polishing and abrasion through use of strontium titanate particles each having a rounded shape that is not a rectangular shape as an external additive for a toner.

According to an investigation made by the inventors, it has been found that the configurations described in U.S. Pat. No. 10,678,153 and Japanese Patent Application Laid-Open No. 2022-34384 each have room for amelioration with regard to the occurrence of image smearing under a high-temperature and high-humidity environment.

Accordingly, an object of the present disclosure is to provide an electrophotographic apparatus that suppresses the occurrence of image smearing under a high-temperature and high-humidity environment.

### SUMMARY OF THE INVENTION

The above-mentioned object is achieved by the present disclosure described below. That is, according to one aspect of the present disclosure, there is provided an electrophotographic apparatus including: an electrophotographic photosensitive member; a charging unit configured to charge a surface of the electrophotographic photosensitive member; an image exposing unit configured to irradiate the charged surface of the electrophotographic photosensitive member with image exposure light to form an electrostatic latent image on the surface of the electrophotographic photosensitive member; a developing unit, which includes a toner, and which is configured to develop the electrostatic latent image formed on the surface of the electrophotographic photosensitive member with the toner to form a toner image on the surface of the electrophotographic photosensitive member; and a transferring unit configured to transfer the toner image formed on the surface of the electrophotographic photosensitive member onto a transfer material, wherein the electrophotographic photosensitive member includes a surface layer containing indium tin oxide particles and a (meth)acrylic resin, and wherein the toner contains strontium titanate particles as an external additive.

Further, according to another aspect of the present disclosure, there is provided an electrophotographic process cartridge including a charging unit, an image exposing unit, and a developing unit through use of the above-mentioned electrophotographic photosensitive member and the above-mentioned toner.

Further features of the present invention will become apparent from the following description of exemplary embodiments with reference to the attached drawing.

### BRIEF DESCRIPTION OF THE DRAWINGS

FIGURE is a view for illustrating an example of the schematic configuration of an electrophotographic apparatus of the present disclosure.

### DESCRIPTION OF THE EMBODIMENTS

The present disclosure is described in detail below by way of exemplary embodiments.

An electrophotographic apparatus according to one aspect of the present disclosure is an electrophotographic apparatus including: an electrophotographic photosensitive member; a charging unit configured to charge a surface of the electrophotographic photosensitive member; an image exposing unit configured to irradiate the charged surface of the electrophotographic photosensitive member with image exposure light to form an electrostatic latent image on the surface of the electrophotographic photosensitive member; a developing unit, which includes a toner, and which is configured to develop the electrostatic latent image formed on the surface of the electrophotographic photosensitive member with the toner to form a toner image on the surface of the electrophotographic photosensitive member; and a transferring unit configured to transfer the toner image formed on the surface of the electrophotographic photosensitive member onto a transfer material, wherein the electrophotographic photosensitive member includes a surface layer containing indium tin oxide particles and a (meth)acrylic resin, and wherein the toner contains strontium titanate particles as an external additive.

Although the surface layer containing a (meth)acrylic resin alone was excellent in abrasion resistance, but image smearing occurred when a toner having the related-art configuration was used.

When a filler such as metal oxide particles was dispersed in a (meth)acrylic resin, the abrasion resistance was further enhanced, but the degree of image smearing was increased. The increase in abrasion resistance results from the action of a so-called filler effect in which the interaction between the filler and the resin is newly added to increase film strength.

Such surface layer is suitable for a long-life photosensitive member. However, a compound having a carboxy group generated by discharge is accumulated without being scraped off because the surface layer is not abraded, resulting in image smearing.

In view of the foregoing, the inventors have made extensive investigations on a method that can achieve high durability and the suppression of image smearing. As a result, the inventors have found that a combination of indium tin oxide particles serving as metal oxide particles to be used in the surface layer and strontium titanate particles serving as an external additive for a toner can suppress the occurrence of image smearing through long-term use and repeated use. Thus, the inventors have reached the present disclosure. The present disclosure is not a method of abrading a photosensitive member with an external additive for a toner to scrape off a compound having a carboxy group as in the related art.

The inventors have assumed the reason why the electrophotographic apparatus of the present disclosure is excellent in suppression of the occurrence of image smearing to be as described below.

The inventors have assumed that, when part of the charge held by indium tin oxide particles present in the vicinity of the surface of the surface layer is transferred to strontium titanate particles, which are more likely to hold the charge, at the time of charging, part of lattices of the strontium titanate particles are distorted, and a compound having a carboxy group is bonded to be incorporated through a hydrogen bond at oxygen and titanium sites in the lattice.

The surface layer of the photosensitive member having the configuration of the present disclosure suppresses scratches and abrasion caused by long-term use or repeated use, and hence it can be said that the suppressing effect on image smearing is not caused by the abrasion effect of the external additive. That is, in the electrophotographic apparatus of the present disclosure, indium tin oxide particles having low resistance capable of smoothly transferring charge at the time of charging are contained in the surface layer containing a (meth)acrylic resin, and the lattice distortion is caused by the configuration of the strontium titanate particles having a high dielectric constant serving as an external additive. The foregoing synergistically draws out the suppression of image smearing. Thus, the electrophotographic apparatus of the present disclosure can be maintained even through long-time use and repeated use.

Through use of the photosensitive member and external additive for a toner of the present disclosure, even in the case of long-term use or repeated use, the compound having a carboxy group is synergistically removed, and hence image quality without the occurrence of image smearing and without image defects caused by scratches can be provided.

The surface layer of the present disclosure is more preferably formed of a polymerization product of a composition containing a monomer represented by any one of (OCL-1) to (OCL-9) described below and indium tin oxide particles from the viewpoint of suppressing image smearing. However, the present disclosure is not limited thereto.

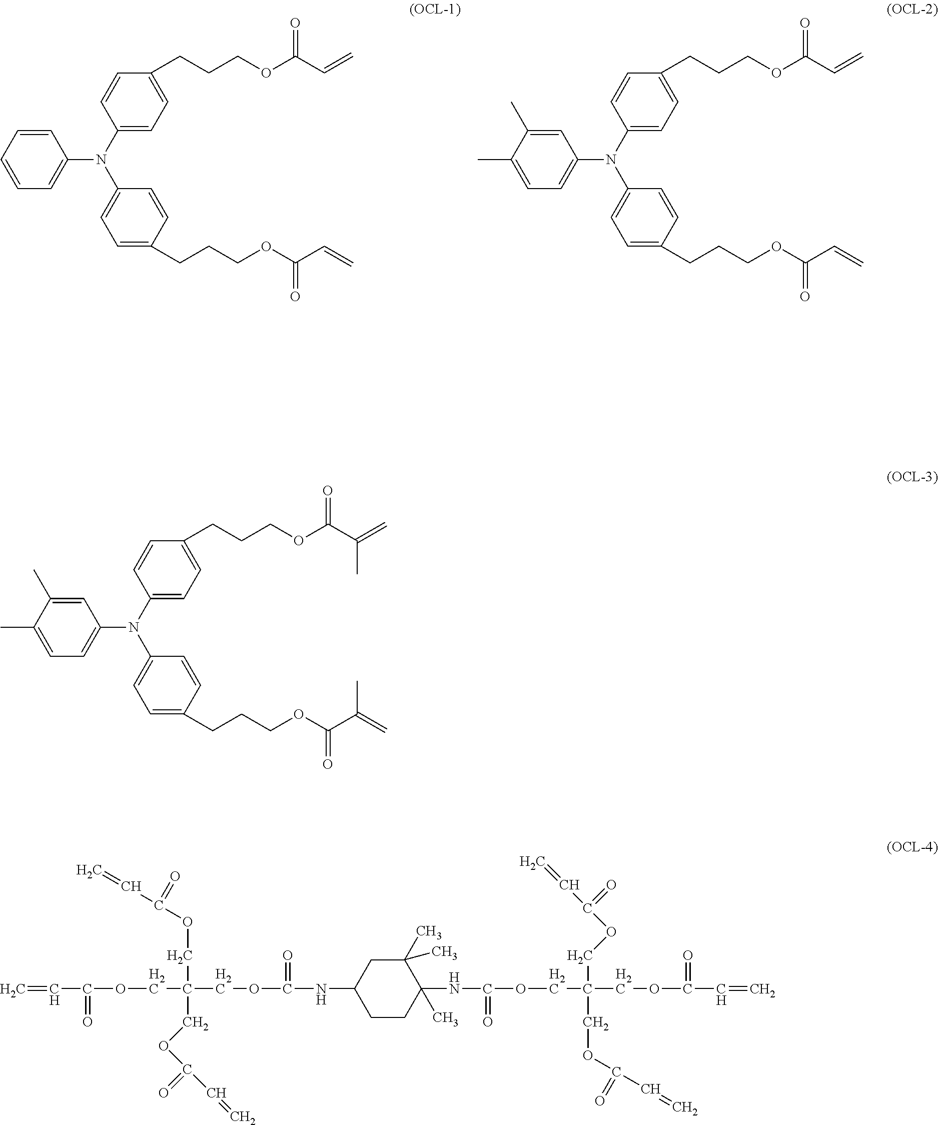 [SMILES: C=CC(=O)OCCCc1ccc(N(c2ccccc2)c2ccc(CCCOC(=O)C=C)cc2)cc1 ; C=CC(=O)OCCCc1ccc(N(c2ccc(CCCOC(=O)C=C)cc2)c2ccc(C)c(C)c2)cc1 ; C=C(C)C(=O)OCCCc1ccc(N(c2ccc(CCCOC(=O)C(=C)C)cc2)c2ccc(C)c(C)c2)cc1 ; C=CC(=O)OCC(COC(=O)C=C)(COC(=O)C=C)COC(=O)NC1CCC(C)(NC(=O)OCC(COC(=O)C=C)(COC(=O)C=C)COC(=O)C=C)C(C)(C)C1]

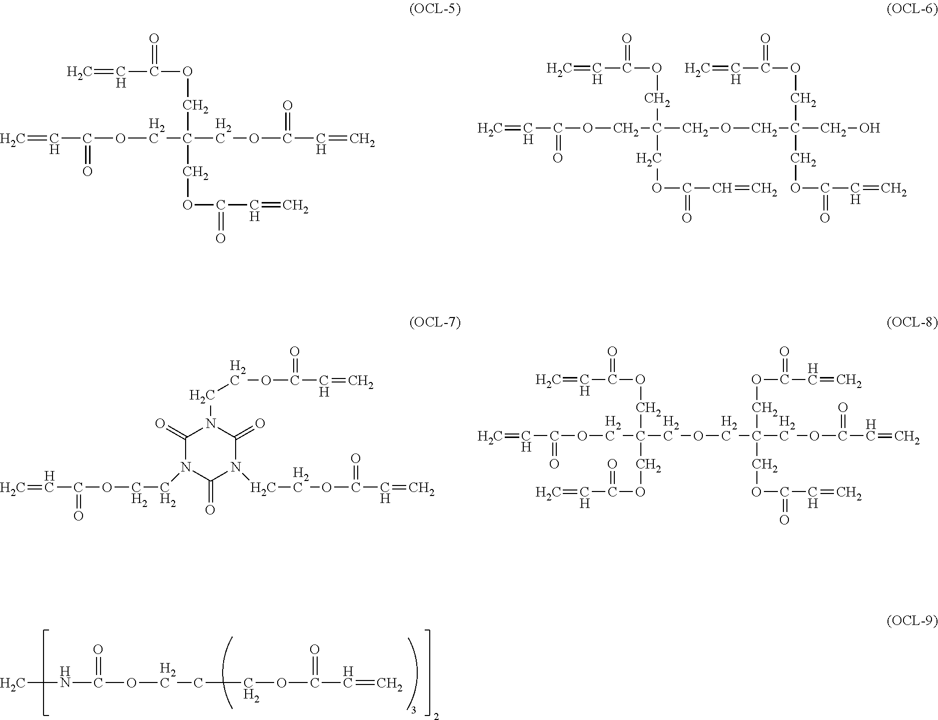

Of those, (OCL-4), (OCL-7), and (OCL-9) each have a urethane bonding site and have high adhesiveness to indium tin oxide particles, and hence detachment is less liable to occur throughout the lifetime. Thus, with such monomer, the effects of the present disclosure are maintained.

In the present disclosure, the compound having a carboxy group generated by discharge refers to (meth)acrylic acid, which is formed by the decomposition of a component in the surface layer, and other low-molecular-weight compounds each having a carboxy group, and includes oxalic acid.

The effects of the present disclosure are exhibited by optimizing the ratio of the mass of indium oxide to the total of the mass of indium oxide and the mass of tin oxide in the indium tin oxide particles.

For example, the ratio of the mass of indium oxide is preferably from 85% to 95%.

The indium tin oxide particles each have a size of preferably an average primary particle diameter of 40 nm or more and 80 nm or less. When the size of each of the indium tin oxide particles falls within the above-mentioned range, the number of opportunities for the indium tin oxide particles to come into contact with the strontium titanate particles serving as an external additive is increased, and hence the effects are further enhanced.

It is preferred that the indium tin oxide particles present in the vicinity of the surface of the surface layer each have a convex shape including three or more indium tin oxide particles on average in an area of a 1 m square of an image of the surface layer obtained by SEM-EDS analysis.

When the ratio B (mass %) of the indium tin oxide particles to the total mass of the surface layer is 5 mass % or more and 30 mass % or less, the number of opportunities for the indium tin oxide particles to come into contact with the strontium titanate particles serving as an external additive is increased, and hence the effects are enhanced.

Further, in the present disclosure, it is preferred that, when the ratio of the mass of the strontium titanate particles serving as the external additive to the total mass of the toner is represented by A (mass %), the A (mass %) be 0.5 mass % or more and 2.5 mass % or less. It has been shown from the results of electron spectroscopy for chemical analysis (ESCA: X-ray photoelectron spectroscopy) of the surface layer that, when the ratio falls within the above-mentioned range, the removing effect on the compound having a carboxy group generated by discharge is high.

Further, it is preferred that, when the ratio of the mass of the strontium titanate particles serving as the external additive to the total mass of the toner is represented by A (mass %), and the ratio of the mass of the indium tin oxide particles to the total mass of the surface layer is represented by B (mass %), the ratio B/A of the B (mass %) to the A (mass %) be 2.5 or more and 35.0 or less. That is, when the amount of the indium tin oxide particles is large, it is preferred that the amount of the strontium titanate particles serving as the external additive be large. In an opposite case, even when the amount of the strontium titanate particles is small, sufficient effects are exhibited. This describes the synergistic effects of the present disclosure. By virtue of such synergistic effects, scratches and an abrasion property in addition to image smearing are further suppressed.

In addition, when the BET specific surface area of the strontium titanate particles serving as an external additive is 70 m²/g or more and 200 m²/g or less, further, 70 m²/g or more and 110 m²/g or less, the effects of the present disclosure are further enhanced. Further, the strontium titanate particles serving as an external additive generally have the effect by which toner chargeability is improved to suppress the adhesion property of the toner to the photosensitive member. In the present disclosure, the effect is exhibited by the electrical interaction between the indium tin oxide particles and the strontium titanate particles in the surface layer. Thus, in the electrophotographic apparatus of the present disclosure, concern has been raised about the occurrence of the adhesion of the toner to the photosensitive member due to the loss of the above-mentioned suppressing effect on the adhesion property. However, it has been found that, image defects, such as fusion or streaks, are not observed on the surface of the photosensitive member while the compound having a carboxy group is suppressed, and the adhesion property of the toner does not deteriorate.

The strontium titanate particles serving as an external additive preferably have an average primary particle diameter of 70 nm or less. When the average primary particle diameter falls within the above-mentioned range, the number of opportunities for the strontium titanate particles to come into contact with the indium tin oxide particles is increased, and hence the effects are further enhanced.

Further, according to another aspect of the present disclosure, there is provided an electrophotographic process cartridge including a charging unit, an image exposing unit, and a developing unit through use of the above-mentioned electrophotographic photosensitive member and toner.

The present disclosure is described more specifically.

The structure or kind of the composition of the surface layer according to the present disclosure may be analyzed by a general analysis method. For example, the structures may be identified by a measurement method, such as solid-state ¹³C-NMR measurement, ¹H-NMR measurement, mass spectrometry measurement, pyrolysis GCMS, SEM-EDS, or characteristic absorption measurement based on infrared spectroscopic analysis.

In the SEM-EDS, a photosensitive member was fixed and cut out into a 10 mm square at a center position with respect to a longitudinal direction of the photosensitive member with a saw, and the resultant was used as a sample.

Elements may be identified by focusing on the surface of the surface layer of the photosensitive member and subjecting the particles to the EDS analysis. In addition, the number of convex shapes may be checked by setting the surface in a direction of 450 oblique to X-ray irradiation of the apparatus.

The particles in the surface layer of the photosensitive member are isolated by burning the organic components in the surface layer, and the composition of the particles may be determined by XRD or X-ray fluorescence.

In addition, the average particle diameters of the indium tin oxide particles and the strontium titanate particles were determined from SEM-EDS images. From photographs of backscattered electron images captured at a magnification of 50,000 times, the average primary particle diameter was calculated by (a+b)/2, where “a” represents the longest side of 100 individual particles and “b” represents the shortest side thereof.

The composition of the external additive may be determined by taking out the toner itself or the external additive alone and performing SEM-EDS, XRD, or X-ray fluorescence analysis.

As a method of taking out the external additive alone, the following may be performed. The external additive is isolated by burning the organic components of the toner. Alternatively, the toner is ultrasonically dispersed in methanol so that the strontium titanate particles or other external additives are detached. The resultant is left to stand still for 24 hours. The toner particles, and the strontium titanate particles or the other external additives are separated from each other by centrifugation, collected, and sufficiently dried. Thus, the toner particles, and the strontium titanate particles or the other external additives are isolated.

In the compound having a carboxy group generated by discharge, a carboxylic acid may be quantified by ESCA.

The compound itself having a carboxy group may be identified through use of ion chromatography or pyrolysis GCMS by collecting a product when only discharge is performed.

### Pyrolysis Gas Chromatography Mass Spectrometry (GCMS)

### Preparation of Measurement Sample

The cured product of the surface layer of the photosensitive member may be identified by the following method.

The surface of the photosensitive member in an area of about 5 cm square is peeled to provide a surface layer sample. The surface layer sample is loaded into 10 g of chlorobenzene, subjected to ultrasonic treatment for 1 minute, and air-dried so that components except the surface layer are removed. The surface layer sample subjected to the above-mentioned treatment is loaded into 10 g of 1-propanol and subjected to ultrasonic treatment for 12 hours, and the resultant solution is concentrated to provide a measurement sample.

### Analysis Conditions

Apparatus configuration: pyrolysis apparatus+gas chromatography (GC) apparatus+mass spectrometry (MS) apparatus
Pyrolysis apparatus: JPS-700 manufactured by Japan Analytical Industry Co., Ltd.
GC apparatus: FOCUS-GC manufactured by Thermo Fisher Scientific Inc.
MS apparatus: ISQ manufactured by Thermo Fisher Scientific Inc.
Sample amount: 0.1 mg (containing TMAH (manufactured by Tama Chemicals Co., Ltd.))
Pyrolysis temperature: 590° C. (using Pyrofoil F590 manufactured by Japan Analytical Industry Co., Ltd.)
Column: “HP5-MS” (19091S-433 manufactured by Agilent Technologies, Inc.,
length: 30 m, inner diameter: 0.25 mm, thickness: 0.25 μm)
   GC inlet conditions:
Inlet temp: 250° C.
Split flow: 50 mL/min
GC temperature increase conditions: 40° C. (5 min)→10° C./min (300° C.)→300° C. (20 min)
   MS conditions:
Ion source temp: 200° C.
MS transfer line temp: 250° C.

### SEM-EDS

### Preparation of Measurement Sample

A conductive carbon tape is bonded to a sample stage. A sample is brought into close contact with the conductive carbon tape, and sputtering is performed with platinum for 30 seconds.

### Analysis Conditions

Apparatus configuration: Scanning electron microscope+energy dispersive X-ray spectrometer (product name: S-4800, manufactured by Hitachi High-Technologies Corporation)
Magnification: 5,000 times to 50,000 times

### ¹H-NMR Measurement

### Preparation of Measurement Sample

20 mg of the sample used in the Pyrolysis GCMS is dissolved in 1 g of deuterated chloroform containing tetramethylsilane serving as a reference substance (deuterated chloroform: manufactured by Sigma-Aldrich Japan G.K., chloroform-d, model number: 612200), and the entire amount is transferred to an NMR tube (NMR tube: manufactured by Norell, Inc., ST500-7, model number: S3010).

### NMR Conditions

Apparatus: AVANCE 500 manufactured by Bruker
Conditions: Proton NMR, automatic measurement by Icon-NMR
Number of scans: 32
Reference peak: The peak of a methyl group of tetramethylsilane is set to 0 ppm.

### X-Ray Diffraction

### Preparation of Measurement Sample

The toner and the photosensitive member are heated, and the remaining residue is collected and used as a sample.

The sample is uniformly loaded into a Boro-Silicate capillary having a diameter of 0.5 mm (manufactured by W. Muller).

### Analysis Conditions

Apparatus name: “SmartLab” (manufactured by Rigaku Corporation, horizontal sample type strong X-ray diffraction apparatus)
Analysis software: “PDXL2 (version 2.2.2.0)”
Tube bulb: Cu
Optical system: CBO-E
Sample stage: capillary sample stage
Detector: D/tex Ultra250 detector
Voltage: 45 kV
Current: 200 mA
Start angle: 10°
End angle: 90°
Sampling width: 0.02°
Speed measurement time set value: 10
IS: 1 mm
RS1: 20 mm
RS2: 20 mm
Attenuator: Open
Capillary rotation speed set value: 100

### X-Ray Fluorescence Analysis

### Preparation of Measurement Sample

About 3 g of toner is loaded into a 27 mm vinyl chloride ring for measurement, and pressed at 200 kN to mold a sample. The weight and thickness of the toner used are recorded.

### Analysis Conditions

Apparatus name: wavelength-dispersive X-ray fluorescence spectrometer “Axios advanced”
Manufacturer: PANalytical
Quantification method: fundamental parameter method (FP method)
Analysis element: B to U
Measurement atmosphere: vacuum
Measurement sample: solid
Collimator mask diameter: 27 mm
Measurement conditions: An automatic program preset to an excitation condition optimum for each element was used.
Measurement time: about 20 minutes

For other conditions, general values recommended for the apparatus were used.

### Analysis

Analysis program: SpectraEvaluation (version 5.0L)
Analysis condition: oxide form
Balance component: CH₂
   (The CHO ratio of the resin is measured in advance by using an analysis technique such as NMR, and is used as the balance.)

For others conditions, general values recommended for the apparatus were used.

### Details of Analysis Conditions

Spectroscopic crystals: LiF220, LiF200, Ge111, TIAP, and PX1
Tube current: 40 mA to 80 mA for each element
Tube voltage: 30 kV to 60 kV for each element
*The product of the tube current and the tube voltage is constantly kept at 2.4 kW.
Bulb filter: Brass (400 μm) is used depending on the element.

The composition of the strontium titanate particles is determined by determining Sr/Ti (mass ratio) excluding oxygen from the results of the above-mentioned quantification, and then converting the ratio to Sr/Ti (molar ratio) based on the atomic weight of each element.

A sample to be used is obtained by isolating the compound containing a titanium atom from the toner including the external additive.

### X-ray Photoelectron Spectroscopy (ESCA)

### Preparation of Measurement Sample

The photosensitive member is cut out into an 8 mm square and set on a sample stage.

### Details of Analysis Conditions

Measurement apparatus: Quantum 2000 (product name, manufactured by ULVAC-PHI, Inc.)
X-ray source: monochromatic Al Kα
X-ray setting: 100 μmφ (25 W (15 KV))
Photoelectron extraction angle: 45°
Neutralization condition: combined use of neutralization gun and ion gun
Analysis region: 300 μm×200 μm
Pass energy: 58.70 eV
Step size: 1.25 eV
Analysis software: Multipak (Physical Electronics, Inc.)

The —C(═O)O bond having a peak in the vicinity of 288.5 eV is focused on, and the generation amount is quantified from a peak area. Peak separation may be performed as required to enhance accuracy. In addition, fluorine may be quantified by causing trifluoroethanol (CF₃CH₂OH) to act on the sample.

The amount (%) of the —C(═O)O bond generated by long-term use or repeated use was determined by the following formula.

$$- C ( = O ) O bond amount ( \% ) = ( ( - C ( = O ) O bond amount area after endurance - - C ( = O ) O bond amount area before endurance ) / - C ( = O ) O bond amount area before endurence ) \times 100$$

### BET Method

### Preparation of Measurement Sample

A tare of a sufficiently washed and dried dedicated glass sample cell (stem diameter: ⅜ inch, volume: 5 mL) is accurately weighed. Then, 0.1 g of strontium titanate particles are loaded into the sample cell through use of a funnel. The sample cell containing the strontium titanate particles is set in a “pretreatment apparatus VacPrep 061 (manufactured by Shimadzu Corporation)” having a vacuum pump and a nitrogen gas pipe connected thereto, and vacuum degassing is continued at 23° C. for 10 hours. After the vacuum degassing is completed, a nitrogen gas is gradually injected to return the inside of the sample cell to an atmospheric pressure, and the sample cell is taken out from the pretreatment apparatus. Then, the mass of the sample cell is accurately weighed, and the exact mass of the strontium titanate particles is calculated from the difference from the tare.

### Analysis Conditions

Automatic specific surface area and pore distribution measuring apparatus: (TriStar 3000 (manufactured by Shimadzu Corporation))
Dedicated software: TriStar 3000 Version 4.00

The relative pressure points, which are values each obtained by dividing the equilibrium pressure in the sample cell by the saturated vapor pressure of nitrogen, are set as a total of six points: 0.05, 0.10, 0.15, 0.20, 0.25, and 0.30 on the horizontal axis, and an adsorption isotherm with a nitrogen adsorption amount (mol/g) on the vertical axis is obtained. Further, a monomolecular layer adsorption amount (mol/g) is determined through use of the BET plots, and the BET specific surface area (m²/g) of the strontium titanate particles is calculated based on the following formula.

$$BET specific surface area ( {m}^{2} \text{/g} ) = monomolecular layer adsorption amount ( mol \text{/g} ) \times N \times 0.162 \times {10}^{- 18} ( where N represents an Avogadro number ( {mol}^{- 1} ) )$$

Identification of Product generated on Surface of Photosensitive Member Discharge to Photosensitive Member
Discharge current amount: Target of 1,415 μA, discharge time: time varied between 50 minutes and 100 minutes.
(Discharge is performed without the toner or sheet passage.)

### Discharge Product Wiping Apparatus

Apparatus: Rotating HEIDON (manufactured by Shinto Scientific Co., Ltd.)
Cloth: KIMTECH pure W3 (manufactured by Nippon Paper Crecia Co., Ltd.)
Cloth size: 10 mm×40 mm (cut out with clean scissors)
Urethane foam: Details are unknown (cut out with a cutter from a packaging material found in the surroundings).
HEIDON load: 1.5 kg, photosensitive member rotation speed: 10 rpm

### Wiping and Extraction

A scotch tape portion to be brought into contact with the cloth is cleaned in advance with a dusper or the like wetted with ultrapure water.

The cloth is held with clean tweezers, and 75 μL each of a total of 150 μL of ultrapure water is dropped onto each side of the cloth folded in four.
After the cloth is blended with the water, the cloth is placed on a drum, and a load is applied thereto from above.
“After 70 rotations of the photosensitive member, the cloth is moved to a new location with tweezers+the cloth is replenished with 35 μL of water” is repeated 5 times.

### Extraction

The cloth is loaded into a plastic container and extracted overnight with 450 μL of ultrapure water.

### Analysis

Measurement was performed with an ion chromatography apparatus (product name “ICS-2000”, manufactured by Dionex Corporation). A product may be identified from ion components in the resultant extraction liquid. In addition, as required, a molecular weight is identified by LC-MS.

### Analysis Conditions

Developing solvent: Water/methanol=1/1

### Weight-Average Particle Diameter of Toner Particles

### Preparation of Measurement Sample

As an electrolytic aqueous solution to be used for the measurement, an electrolytic aqueous solution obtained by dissolving special-grade sodium chloride in ion-exchanged water to a concentration of 1.0 mass %, such as “ISOTON II” (manufactured by Beckman Coulter, Inc.) may be used.

A required electrolytic aqueous solution is prepared in a beaker, and 10 mg of a toner is added to the electrolytic aqueous solution in small quantities under irradiation with an ultrasonic wave to be dispersed therein. Then, the ultrasonic dispersion treatment is further continued for 60 seconds.

### Analysis Conditions

Measuring apparatus: Precision particle size distribution measuring apparatus “Coulter Counter Multisizer 3” (trademark) (manufactured by Beckman Coulter, Inc.)
Measuring conditions/analysis: The attached dedicated software “Beckman Coulter Multisizer 3 Version 3.51” (manufactured by Beckman Coulter, Inc.)

Measurement is performed with 25,000 effective measurement channels.

In the “Change Standard Measuring Method (SOMME)” screen of the dedicated software, the total count of particles in a control mode is set to 50,000 particles, the number of times of measurement is set to 1, and the Kd value is set to the value obtained through use of the “standard particles 10.0 μm” (manufactured by Beckman Coulter, Inc.). The threshold value and the noise level are automatically set by pressing the “Threshold Value/Noise Level Measurement” button. In addition, the current is set to 1,600 μA, the gain is set to 2, and the electrolytic solution is set to ISOTON II, and the “Flush of Aperture Tube after Measurement” is checked. In the “Pulse-to-Particle Diameter Conversion Setting” screen of the dedicated software, the bin interval is set to a logarithmic particle diameter, the particle diameter bin is set to 256 particle diameter bins, and the particle diameter range is set to from 2 μm to 60 μm.

The details are further described below.

### [Electrophotographic Photosensitive Member]

The electrophotographic photosensitive member according to one aspect of the present disclosure includes a support and a photosensitive layer. Further, the electrophotographic photosensitive member may include a protective layer on the photosensitive layer. In the case where the photosensitive member does not include the protective layer, the photosensitive layer serves as a surface layer, and when the photosensitive layer is a laminate type, a charge-transporting layer of the laminate serves as the surface layer. In the case where the photosensitive member includes the protective layer, the protective layer serves as the surface layer.

A method of producing the electrophotographic photosensitive member of the present disclosure is, for example, a method involving: preparing coating liquids for the respective layers to be described later; applying the liquids in a desired order of the layers; and drying the liquids. In this case, examples of a method of applying the coating liquid include dip coating, spray coating, inkjet coating, roll coating, die coating, blade coating, curtain coating, wire bar coating, and ring coating. Of those, dip coating is preferred from the viewpoints of efficiency and productivity.

The respective layers are described below.

### <Support>

In the present disclosure, the electrophotographic photosensitive member includes a support. In the present disclosure, the support is preferably a conductive support having conductivity. In addition, examples of the shape of the support include a cylindrical shape, a belt shape, and a sheet shape. A support having a cylindrical shape out of those shapes is preferred. In addition, the outer surface of the support may be subjected to, for example, electrochemical treatment such as anodization to form an oxide film, blast treatment, or cutting treatment. A metal, a resin, glass, or the like is preferred as a material for the support.

Examples of the metal include aluminum, iron, nickel, copper, gold, stainless steel, and alloys thereof. An aluminum support using aluminum out of those metals is preferred. The support is more preferably an aluminum alloy having an oxide film on an outer surface thereof. The presence of the oxide film can suppress the injection of charge from the support, and hence a suppressing effect on the occurrence of a black spot under a high-humidity environment is large.

In addition, conductivity may be imparted to the resin or the glass through treatment involving, for example, mixing or coating the resin or the glass with a conductive material.

### <Conductive Layer>

In the present disclosure, a conductive layer may be arranged on the support. The arrangement of the conductive layer can conceal flaws and irregularities in the surface of the support, and control the reflection of light on the surface of the support.

The conductive layer preferably contains conductive particles and a resin.

A material for the conductive particles is, for example, a metal oxide, a metal, or carbon black.

Examples of the metal oxide include zinc oxide, aluminum oxide, indium oxide, silicon oxide, zirconium oxide, tin oxide, titanium oxide, magnesium oxide, antimony oxide, and bismuth oxide. Examples of the metal include aluminum, nickel, iron, nichrome, copper, zinc, and silver.

Of those, a metal oxide is preferably used as the conductive particles, and in particular, titanium oxide, tin oxide, and zinc oxide are more preferably used.

When the metal oxide is used as the conductive particles, the surface of the metal oxide may be treated with a silane coupling agent or the like, or the metal oxide may be doped with an element, such as phosphorus or aluminum, or an oxide thereof.

In addition, each of the conductive particles may be of a laminated construction having a core particle and a coating layer coating the particle. Examples of the core particle include titanium oxide, barium sulfate, and zinc oxide. The coating layer is, for example, a metal oxide such as tin oxide.

In addition, when the metal oxide is used as the conductive particles, their volume-average particle diameter is preferably 1 nm or more and 500 nm or less, more preferably 3 nm or more and 400 nm or less.

Examples of the resin include a polyester resin, a polycarbonate resin, a polyvinyl acetal resin, an acrylic resin, a silicone resin, an epoxy resin, a melamine resin, a polyurethane resin, a phenol resin, and an alkyd resin.

In addition, the conductive layer may further contain a silicone oil, resin particles, or a concealing agent such as titanium oxide.

The conductive layer has an average thickness of preferably 1 μm or more and 50 μm or less, particularly preferably 3 μm or more and 40 μm or less.

The conductive layer may be formed by preparing a coating liquid for a conductive layer containing the above-mentioned materials and a solvent, forming a coat thereof, and drying the coat. Examples of the solvent to be used for the coating liquid include an alcohol-based solvent, a sulfoxide-based solvent, a ketone-based solvent, an ether-based solvent, an ester-based solvent, and an aromatic hydrocarbon-based solvent. As a dispersion method for dispersing the conductive particles in the coating liquid for a conductive layer, there are given methods using a paint shaker, a sand mill, a ball mill, and a liquid collision-type high-speed disperser.

### <Undercoat Layer>

In the present disclosure, an undercoat layer may be arranged on the support or the conductive layer. The arrangement of the undercoat layer can improve an adhesive function between layers to impart a charge injection-inhibiting function.

The undercoat layer preferably contains a resin. In addition, the undercoat layer may be formed as a cured film by polymerizing a composition containing a monomer having a polymerizable functional group.

Examples of the resin include a polyester resin, a polycarbonate resin, a polyvinyl acetal resin, an acrylic resin, an epoxy resin, a melamine resin, a polyurethane resin, a phenol resin, a polyvinyl phenol resin, an alkyd resin, a polyvinyl alcohol resin, a polyethylene oxide resin, a polypropylene oxide resin, a polyamide resin, a polyamic acid resin, a polyimide resin, a polyamide imide resin, and a cellulose resin.

Examples of the polymerizable functional group of the monomer having a polymerizable functional group include an isocyanate group, a blocked isocyanate group, a methylol group, an alkylated methylol group, an epoxy group, a metal alkoxide group, a hydroxy group, an amino group, a carboxy group, a thiol group, a carboxylic acid anhydride group, and a carbon-carbon double bond group.

In addition, the undercoat layer may further contain an electron-transporting substance, a metal oxide, a metal, a conductive polymer, and the like for the purpose of improving electric characteristics. Of those, an electron-transporting substance and a metal oxide are preferably used.

Examples of the electron-transporting substance include a quinone compound, an imide compound, a benzimidazole compound, a cyclopentadienylidene compound, a fluorenone compound, a xanthone compound, a benzophenone compound, a cyanovinyl compound, a halogenated aryl compound, a silole compound, and a boron-containing compound. An electron-transporting substance having a polymerizable functional group may be used as the electron-transporting substance and copolymerized with the above-mentioned monomer having a polymerizable functional group to form the undercoat layer as a cured film.

Examples of the metal oxide include indium tin oxide, tin oxide, indium oxide, titanium oxide, zinc oxide, aluminum oxide, and silicon dioxide. Examples of the metal include gold, silver, and aluminum.

In addition, the undercoat layer may further contain an additive.

The average thickness of the undercoat layer is preferably 0.1 μm or more and 50 μm or less, more preferably 0.2 μm or more and 40 μm or less, particularly preferably 0.3 μm or more and 30 μm or less.

The undercoat layer may be formed by preparing a coating liquid for an undercoat layer containing the above-mentioned materials and a solvent, forming a coat thereof, and drying and/or curing the coat. Examples of the solvent to be used for the coating liquid include an alcohol-based solvent, a ketone-based solvent, an ether-based solvent, an ester-based solvent, and an aromatic hydrocarbon-based solvent.

### <Photosensitive Layer>

The photosensitive layers of electrophotographic photosensitive members are mainly classified into (1) a laminate-type photosensitive layer and (2) a monolayer-type photosensitive layer. (1) The laminate-type photosensitive layer has a charge-generating layer containing a charge-generating substance and a charge-transporting layer containing a charge-transporting substance. (2) The monolayer-type photosensitive layer has a photosensitive layer containing both a charge-generating substance and a charge-transporting substance.

### (1) Laminate-Type Photosensitive Layer

The laminate-type photosensitive layer has the charge-generating layer and the charge-transporting layer.

### (1-1) Charge-Generating Layer

The charge-generating layer preferably contains the charge-generating substance and a resin.

Examples of the charge-generating substance include azo pigments, perylene pigments, polycyclic quinone pigments, indigo pigments, and phthalocyanine pigments. Of those, azo pigments and phthalocyanine pigments are preferred. Of the phthalocyanine pigments, an oxytitanium phthalocyanine pigment, a chlorogallium phthalocyanine pigment, and a hydroxygallium phthalocyanine pigment are preferred.

The content of the charge-generating substance in the charge-generating layer is preferably 40 mass % or more and 85 mass % or less, more preferably 60 mass % or more and 80 mass % or less with respect to the total mass of the charge-generating layer.

Examples of the resin include a polyester resin, a polycarbonate resin, a polyvinyl acetal resin, a polyvinyl butyral resin, an acrylic resin, a silicone resin, an epoxy resin, a melamine resin, a polyurethane resin, a phenol resin, a polyvinyl alcohol resin, a cellulose resin, a polystyrene resin, a polyvinyl acetate resin, and a polyvinyl chloride resin. Of those, a polyvinyl butyral resin is more preferred.

In addition, the charge-generating layer may further contain an additive, such as an antioxidant or a UV absorber. Specific examples thereof include a hindered phenol compound, a hindered amine compound, a sulfur compound, a phosphorus compound, and a benzophenone compound.

The charge-generating layer has an average thickness of preferably 0.1 μm or more and 1 μm or less, more preferably 0.15 μm or more and 0.4 μm or less.

The charge-generating layer may be formed by preparing a coating liquid for a charge-generating layer containing the above-mentioned materials and a solvent, forming a coat thereof, and drying the coat. Examples of the solvent to be used for the coating liquid include an alcohol-based solvent, a sulfoxide-based solvent, a ketone-based solvent, an ether-based solvent, an ester-based solvent, and an aromatic hydrocarbon-based solvent.

### (1-2) Charge-Transporting Layer

The charge-transporting layer preferably contains the charge-transporting substance and a resin.

Examples of the charge-transporting substance include a polycyclic aromatic compound, a heterocyclic compound, a hydrazone compound, a styryl compound, an enamine compound, a benzidine compound, a triarylamine compound, and a resin having a group derived from each of those substances. Of those, a triarylamine compound and a benzidine compound are preferred.

Examples of the resin include a polyester resin, a polycarbonate resin, an acrylic resin, and a polystyrene resin. Of those, a polycarbonate resin is preferred.

A content ratio (mass ratio) between the charge-transporting substance and the resin is preferably from 5:10 to 12:10.

In addition, the charge-transporting layer may contain an additive, such as an antioxidant, a UV absorber, a plasticizer, a leveling agent, a slipperiness-imparting agent, or an abrasion resistance improver. Specific examples thereof include a hindered phenol compound, a hindered amine compound, a sulfur compound, a phosphorus compound, a benzophenone compound, a siloxane-modified resin, a silicone oil, fluororesin particles, polystyrene resin particles, polyethylene resin particles, silica particles, alumina particles, and boron nitride particles.

The charge-transporting layer has an average thickness of preferably 5 μm or more and 30 μm or less, more preferably 10 μm or more and 20 μm or less. The charge-transporting layer may be formed by preparing a coating liquid for a charge-transporting layer containing the above-mentioned materials and a solvent, forming a coat thereof, and drying the coat. Examples of the solvent to be used for the coating liquid include an alcohol-based solvent, a ketone-based solvent, an ether-based solvent, an ester-based solvent, and an aromatic hydrocarbon-based solvent. Of those solvents, an ether-based solvent or an aromatic hydrocarbon-based solvent is preferred.

When the charge-transporting layer serves as the surface layer, the charge-transporting layer contains the above-mentioned indium tin oxide particles and (meth)acrylic resin.

### (2) Monolayer-Type Photosensitive Layer

The monolayer-type photosensitive layer may be formed by preparing a coating liquid for a photosensitive layer containing the charge-generating substance, the charge-transporting substance, a resin, and a solvent, forming a coat thereof, and drying the coat. Examples of the charge-generating substance, the charge-transporting substance, and the resin are the same as those of the materials in the section “(1) Laminate-type Photosensitive Layer.”

When the monolayer-type photosensitive layer serves as the surface layer, the monolayer-type photosensitive layer contains the above-mentioned indium tin oxide particles and (meth)acrylic resin.

### <Protective Layer>

The protective layer may be arranged on the photosensitive layer. When the protective layer serves as the surface layer, the protective layer contains the above-mentioned indium tin oxide particles and (meth)acrylic resin.

As described above, the protective layer is formed of a polymerization product of a composition containing a monomer having a (meth)acrylic polymerizable functional group and indium tin oxide particles. A reaction in this case is, for example, a thermal polymerization reaction, a photopolymerization reaction, or a radiation polymerization reaction.

The protective layer may contain an additive, such as an antioxidant, a UV absorber, a plasticizer, leveling agent, a slipperiness-imparting agent, or an abrasion resistance improver. Specific examples thereof include a hindered phenol compound, a hindered amine compound, a sulfur compound, a phosphorus compound, a benzophenone compound, a siloxane-modified resin, a silicone oil, fluororesin particles, polystyrene resin particles, polyethylene resin particles, and silica particles.

The average thickness of the protective layer is preferably 0.5 μm or more and 10 μm or less, more preferably 1 μm or more and 5 μm or less.

The protective layer may be formed by preparing a coating liquid for a protective layer containing the above-mentioned materials and a solvent, forming a coat thereof, and drying and/or curing the coat. Examples of the solvent to be used in the coating liquid include an alcohol-based solvent, a ketone-based solvent, an ether-based solvent, a sulfoxide-based solvent, an ester-based solvent, and an aromatic hydrocarbon-based solvent.

### <Toner>

In addition to the features described above, the toner according to the present disclosure has the following features.

The weight-average molecular weight of the resin for forming the toner particles is preferably 5,000 or more and 50,000 or less, more preferably 10,000 or more and 30,000 or less.

As the resin for forming the toner particles, a styrene-acrylic resin, an amorphous polyester resin, and a crystalline polyester resin may be used, and these resins may be used alone or in combination thereof.

An example of the styrene-acrylic resin is a styrene-butyl acrylate resin or a styrene-butyl methacrylate resin obtained through a reaction between a styrene monomer and an acrylic monomer.

As constituent components of the amorphous polyester resin, there are given an alcohol component that is dihydric or more, and carboxylic acid components, such as a carboxylic acid that is divalent or more, a carboxylic anhydride that is divalent or more, and a carboxylic acid ester that is divalent or more.

With regard to constituent components of the crystalline polyester resin, a condensate of an aliphatic dicarboxylic acid and an aliphatic diol, and an aliphatic monocarboxylic acid and/or an aliphatic monoalcohol is preferred. A condensate of an aliphatic dicarboxylic acid and an aliphatic diol, and an aliphatic monocarboxylic acid is more preferred. The incorporation of the aliphatic monocarboxylic acid and/or the aliphatic monoalcohol as a constituent component of the crystalline polyester resin facilitates the adjustment of the molecular weight and hydroxyl value of the crystalline polyester resin, and besides, allows affinity with a wax to be controlled, and is hence preferred.

The toner particles may each contain a wax. Examples of the wax include the following: petroleum-based waxes, such as paraffin wax, microcrystalline wax, and petrolatum, and derivatives thereof; montan wax and a derivative thereof; hydrocarbon waxes by the Fischer-Tropsch process and derivatives thereof; polyolefin waxes, such as polyethylene wax and polypropylene wax, and derivatives thereof; natural waxes, such as carnauba wax and candelilla wax, and derivatives thereof; higher aliphatic alcohols; fatty acids, such as stearic acid and palmitic acid; acid amide waxes; and ester waxes.

Examples of the derivatives include oxides, and block copolymerization products or graft-modified products with vinyl-based monomers.

The content of the wax is preferably 2.0 parts by mass or more and 15.0 parts by mass or less, more preferably 2.0 parts by mass or more and 10.0 parts by mass or less with respect to 100.0 parts by mass of polymerizable monomers capable of generating the binder resin or the binder resin.

The toner particles may each contain a colorant. As a black colorant, there are given carbon black, a magnetic material, and a colorant toned black using the following yellow, magenta, and cyan colorants.

Examples of the yellow colorant include a condensed azo compound, an isoindolinone compound, an anthraquinone compound, an azo metal complex, a methine compound, and an allylamide compound.

Specific examples thereof include C.I. Pigment Yellow 12, 13, 14, 15, 17, 62, 73, 74, 83, 93, 94, 95, 97, 109, 110, 111, 120, 128, 129, 138, 147, 150, 151, 154, 155, 168, 180, 185, and 214.

Examples of the magenta colorant include a condensed azo compound, a diketopyrrolopyrrole compound, an anthraquinone compound, a quinacridone compound, a basic dye lake compound, a naphthol compound, a benzimidazolone compound, a thioindigo compound, and a perylene compound.

Specific examples thereof include C.I. Pigment Red 2, 3, 5, 6, 7, 23, 48:2, 48:3, 48:4, 57:1, 81:1, 122, 146, 166, 169, 177, 184, 185, 202, 206, 220, 221, 238, 254, and 269, and C.I. Pigment Violet 19.

Examples of the cyan colorant include a copper phthalocyanine compound and a derivative thereof, an anthraquinone compound, and a basic dye lake compound.

Specific examples thereof include C.I. Pigment Blue 1, 7, 15, 15:1, 15:2, 15:3, 15:4, 60, 62, and 66.

The colorants may be used alone or as a mixture thereof, or may be used in a solid solution state.

It is appropriate to select the colorant from the viewpoints of a hue angle, chroma, lightness, light fastness, OHP transparency, and dispersibility in the toner.

The content of the colorant is preferably 1 part by mass or more and 20 parts by mass or less with respect to 100 parts by mass of the polymerizable monomers capable of generating the binder resin or the binder resin.

The toner particles may be turned to magnetic toner particles by incorporating a magnetic material thereinto as the colorant. Examples of the magnetic material include: iron oxides, such as magnetite, hematite, and ferrite; metals such as iron, cobalt, and nickel or alloys of these metals with metals such as aluminum, copper, magnesium, tin, zinc, beryllium, calcium, manganese, selenium, titanium, tungsten, and vanadium; and mixtures thereof.

The magnetic material is preferably a magnetic material having a modified surface.

When the magnetic toner particles are prepared by a polymerization method, the magnetic material is preferably a material hydrophobized with a surface modifier that is a substance that does not inhibit polymerization. Examples of such surface modifier may include a silane coupling agent and a titanium coupling agent.

The average particle diameter of the magnetic material is preferably 2.0 μm or less, more preferably 0.1 μm or more and 0.5 μm or less.

The content of the magnetic material is preferably 20 parts by mass or more and 200 parts by mass or less, more preferably 40 parts by mass or more and 150 parts by mass or less with respect to 100 parts by mass of the polymerizable monomers capable of generating the binder resin or the binder resin.

An example of a production method for producing the toner particles by a pulverization method is described below.

In a raw material-mixing step, the binder resin, the colorant, the wax, and the like serving as materials for forming the toner are weighed out in predetermined amounts, blended, and mixed.

A mixing apparatus is exemplified by a double cone mixer, a V-type mixer, a drum-type mixer, a super mixer, an FM mixer, a Nauta mixer, and Mechano Hybrid (manufactured by Nippon Coke and Engineering Co., Ltd.).

Next, the mixed materials are melt-kneaded to disperse the colorant, the wax, and the like in the binder resin. In the melt-kneading step, a batch type kneading machine, such as a pressure kneader or a Banbury mixer, or a continuous kneading machine may be used. Because of an advantage in that continuous production can be performed, a single-screw or twin-screw extruder is mainly used. Examples thereof include a KTK-type twin-screw extruder (manufactured by Kobe Steel, Ltd.), a TEM-type twin-screw extruder (manufactured by Toshiba Machine Co., Ltd.), a PCM kneader (manufactured by Ikegai Corp), a twin-screw extruder (manufactured by KCK), a co-kneader (manufactured by BUSS), and Kneadex (manufactured by Nippon Coke & Engineering Co., Ltd.). Further, a resin composition obtained by the melt-kneading is rolled with a two-roll mill or the like, and may be cooled with water or the like in a cooling step.

Then, the resultant cooled product is pulverized in a pulverizing step to a desired particle diameter.

In the pulverizing step, for example, the cooled product is coarsely pulverized with a pulverizer, such as a crusher, a hammer mill, or a feather mill. After that, it is appropriate that the coarsely pulverized product be finely pulverized with Kryptron System (manufactured by Kawasaki Heavy Industries, Ltd.), Super Rotor (manufactured by Nisshin Engineering Inc.), Turbo Mill (manufactured by Freund-Turbo Corporation), or a fine pulverizer of an air-jet system.

After that, as required, the pulverized product is classified using a classifier or a sieving machine, such as Elbow-Jet (manufactured by Nittetsu Mining Co., Ltd.) of an inertial classification system, Turboplex (manufactured by Hosokawa Micron Corporation) of a centrifugal force classification system, TSP Separator (manufactured by Hosokawa Micron Corporation), or Faculty (manufactured by Hosokawa Micron Corporation). Thus, the toner is obtained.

In addition, the toner particles may be spheroidized. For example, after the pulverization, it is appropriate that the pulverized product be spheroidized using Hybridization System (manufactured by Nara Machinery Co., Ltd.), Mechanofusion System (manufactured by Hosokawa Micron Corporation), Faculty (manufactured by Hosokawa Micron Corporation), or Meteorainbow MR Type (manufactured by Nippon Pneumatic Mfg. Co., Ltd.).

The toner may contain an external additive except the strontium titanate particles. In particular, in order to improve the fluidity and chargeability of the toner, a chargeability or fluidity improver may be added.

The ratio of the strontium titanate particles to the total mass of the toner is preferably 0.5 mass % or more and 2.5 mass % or less. The content of the external additives for improving the chargeability is preferably 0.6 mass % or more in total with respect to 100 parts by mass of the toner.

The following external additives may each be used as the external additive for improving the chargeability.

Examples thereof include compounds including: fluorine-based resin powders, such as vinylidene fluoride fine powder and polytetrafluoroethylene fine powder; and silica particles, such as wet process silica and dry process silica, titanium oxide particles, alumina particles, barium titanate particles, calcium titanate particles, strontium zirconate particles, calcium zirconate particles, calcium carbonate particles, magnesium carbonate particles, or hydrophobizing-treated particles obtained by subjecting the above-mentioned particles to surface treatment with a hydrophobizing treatment agent, such as a silane compound, a titanium coupling agent, or a silicone oil.

As the silica particles, dry process silica particles, which are particles produced through the vapor phase oxidation of a silicon halide compound, and which are called dry process silica or fumed silica, are preferred. The dry process utilizes, for example, a pyrolysis oxidation reaction in an oxyhydrogen flame of a silicon tetrachloride gas, and a basic reaction formula therefor is as described below.

SiCl₄+2H₂+O₂→SiO₂+4HCl

In this production process, composite fine particles of silica and any other metal oxide may be obtained by using any other metal halide compound, such as aluminum chloride or titanium chloride, together with the silicon halide compound, and the silica fine particles encompass the composite fine particles as well.

The chargeability or fluidity improver preferably has a number-average particle diameter of primary particles of 5 nm or more and 70 nm or less because high chargeability or fluidity can be imparted.

As a mixer for mixing the external additive, there are given FM Mixer (manufactured by Nippon Coke & Engineering Co., Ltd.), Super Mixer (manufactured by Kawata Mfg. Co., Ltd.), Nobilta (manufactured by Hosokawa Micron Corporation), and Hybridizer (manufactured by Nara Machinery Co., Ltd.).

In addition, after the mixing with the external additive, the coarse particles may be sieved. As a sieving apparatus to be used for that purpose, there are given: Ultrasonic (manufactured by Koei Sangyo Co., Ltd.); Resonasieve and Gyro-Sifter (manufactured by Tokuju Corporation); Vibrasonic System (manufactured by Dalton Corporation); Soniclean (manufactured by Shintokogio Ltd.); Turbo Screener (manufactured by Freund-Turbo Corporation); and Microsifter (manufactured by Makino mfg Co., Ltd.).

### [Electrophotographic Apparatus and Process Cartridge]

In addition, an electrophotographic apparatus according to one aspect of the present disclosure is characterized by including the electrophotographic photosensitive member described above, a charging unit, an image exposing unit, a developing unit, and a transferring unit.

An electrophotographic process cartridge (process cartridge) according to one aspect of the present disclosure is characterized by integrally supporting the electrophotographic photosensitive member described in the foregoing, and at least one unit selected from the group consisting of: a charging unit; a developing unit; a transferring unit; and a cleaning unit, and being removably mounted onto the main body of an electrophotographic apparatus.

An example of the schematic configuration of an electrophotographic apparatus including a process cartridge 11 including an electrophotographic photosensitive member is illustrated in FIGURE.

A cylindrical electrophotographic photosensitive member 1 is rotationally driven about a shaft 2 in a direction indicated by the arrow at a predetermined peripheral speed. The surface of the electrophotographic photosensitive member 1 is charged to a predetermined positive or negative potential by a charging unit 3. In FIGURE, a roller charging system based on a roller-type charging member is illustrated, but a charging system such as a corona charging system, a proximity charging system, or an injection charging system may be adopted. The charged surface of the electrophotographic photosensitive member 1 is irradiated with exposure light 4 from an image exposing unit (not shown), and hence an electrostatic latent image corresponding to target image information is formed thereon. The electrostatic latent image formed on the surface of the electrophotographic photosensitive member 1 is developed by supplying a toner stored in a developing unit 5, and a toner image is formed on the surface of the electrophotographic photosensitive member 1. The toner image formed on the surface of the electrophotographic photosensitive member 1 is transferred onto a transfer material 7 by a transferring unit 6. The transfer material 7 onto which the toner image has been transferred is conveyed to a fixing unit 8, is subjected to treatment for fixing the toner image, and is printed out to the outside of the electrophotographic apparatus. The electrophotographic apparatus may include a cleaning unit 9 for removing a deposit, such as the toner remaining on the surface of the electrophotographic photosensitive member 1 after the transfer. The cleaning unit is preferably a cleaning blade containing a urethane resin. In addition, a so-called cleaner-less system configured to remove the deposit with the developing unit or the like without separate arrangement of the cleaning unit may be used. The electrophotographic apparatus may include an electricity-removing mechanism configured to subject the surface of the electrophotographic photosensitive member 1 to electricity-removing treatment with pre-exposure light 10 from a pre-exposing unit (not shown). In addition, a guiding unit 12 such as a rail may be arranged for removably mounting a process cartridge 11 according to one aspect of the present disclosure onto the main body of an electrophotographic apparatus.

The electrophotographic photosensitive member according to one aspect of the present disclosure can be used in, for example, a laser beam printer, an LED printer, a copying machine, a facsimile, and a multifunctional peripheral thereof.

According to the present disclosure, there can be provided an electrophotographic apparatus that suppresses the occurrence of image smearing through long-term use or repeated use.

### EXAMPLES

The present disclosure is described in more detail below by way of Examples and Comparative Examples. The present disclosure is by no means limited to the following Examples, and various modifications may be made without departing from the gist of the present disclosure. In the description of the following Examples, “part(s)” is by mass unless otherwise specified.

### <Production of Resin>

### Production of Styrene-Acrylic Resin A

The following materials were loaded into a reaction vessel including a reflux condenser, a stirrer, and a nitrogen inlet tube under a nitrogen atmosphere.

| Material | Blending amount | |
|---|---|---|
| Styrene | 79.0 | parts |
| Toluene | 100.0 | parts |
| n-Butyl acrylate | 20.0 | parts |
| Acrylic acid | 1.0 | part |
| Di-t-butyl peroxide (PBD) | 7.2 | parts |

The contents of the vessel were stirred at 200 rotations per minute, heated to 110° C., and stirred for 10 hours. Further, the contents were heated to 140° C. and polymerized for 6 hours. The solvent was evaporated. Thus, a styrene-acrylic resin A was obtained.

### Production Example of Polyester Resin A

The following monomers were loaded into a reaction vessel including a nitrogen inlet tube, a dehydration tube, a stirrer, and a thermocouple.

| | |
|---|---|
| Terephthalic acid: | 30.0 mol % |
| Trimellitic acid: | 10.0 mol % |
| Fumaric acid: | 10.0 mol % |
| Polyoxypropylene 2 mol adduct of bisphenol A: | 25.0 mol % |
| Polyoxyethylene 2 mol adduct of bisphenol A: | 25.0 mol % |

After that, 1.5 parts by mass of dibutyltin was added as a catalyst with respect to 100 parts by mass of the total amount of the monomers.

Next, under a nitrogen atmosphere, the temperature in the reaction vessel was quickly increased to 180° C. at normal pressure, and then polycondensation was performed by evaporating water under heating from 180° C. to 210° C. at a rate of 10° C./hour.

After the temperature had reached 210° C., the pressure in the reaction vessel was reduced to 5 kPa or less, and polycondensation was performed under the conditions of 210° C. and 5 kPa or less to provide a polyester resin A.

### Production Example of Polyester Resin B

The following monomers were loaded into a reaction vessel including a nitrogen inlet tube, a dehydration tube, a stirrer, and a thermocouple.

| | |
|---|---|
| 1,10-Decanediol (alcohol monomer): | 50.0 mol % |
| Sebacic acid (carboxylic acid monomer): | 50.0 mol % |

1 Part by mass of tin dioctoate was added as a catalyst with respect to 100 parts by mass of the total amount of the monomers described above. The inside of the reaction vessel was heated to 140° C. under a nitrogen atmosphere, and the monomers were subjected to a reaction for 6 hours while water was evaporated from the inside of the reaction vessel under normal pressure.

Next, the monomers were subjected to a reaction while the temperature in the reaction vessel was increased to 200° C. at a temperature increase rate of 10° C./hour. After the temperature in the reaction vessel had reached 200° C., the monomers were further subjected to a reaction for 2 hours. After that, the pressure in the reaction vessel was reduced to 5 kPa or less, and the monomers were subjected to a reaction at 200° C. for 6 hours to provide a polyester resin B.

### Production Example of Polyester Resin C

| | |
|---|---|
| Terephthalic acid: | 11.1 mol |
| Bisphenol A-propylene oxide 2 mol adduct (PO-BPA): | 10.9 mol |

The above-mentioned monomers were loaded into an autoclave together with an esterification catalyst, and a pressure reducing device, a water separating device, a nitrogen gas inlet device, a temperature measuring device, and a stirring device were mounted to the autoclave. The monomers were subjected to a reaction at a temperature of 215° C. in accordance with an ordinary method until the glass transition temperature Tg reached 70° C. while the pressure was reduced under a nitrogen atmosphere. Thus, a polyester resin C was obtained.

### Production Example of Polyester Resin D

| | | |
|---|---|---|
| Bisphenol A-ethylene oxide 2 mol adduct: | 725 | parts by mass |
| Phthalic acid: | 285 | parts by mass |
| Dibutyltin oxide: | 2.5 | parts by mass |

The above-mentioned materials were subjected to a reaction under stirring at a temperature of 220° C. for 7 hours, and were further subjected to a reaction for 5 hours under reduced pressure. After that, the materials were cooled to 80° C. and added to an ethyl acetate solution of 190 parts by mass of isophorone diisocyanate. After that, the materials were subjected to a reaction for 2 hours to provide an isocyanate group-containing polyester resin. Through use of a portion of the resultant reaction liquid as it was, 25 parts by mass of the isocyanate group-containing polyester resin and 1 part by mass of isophorone diamine were subjected to a reaction at 50° C. for 2 hours to provide a polyester resin D containing a urea group-containing polyester as a main component.

### <Production of Strontium Titanate Particles (A-1)>

A hydrous titanium oxide slurry obtained by hydrolyzing a titanyl sulfate aqueous solution was washed with an alkali aqueous solution. Next, hydrochloric acid was added to the hydrous titanium oxide slurry to adjust the pH to 0.7. Thus, a titania sol dispersion liquid was obtained. NaOH was added to the titania sol dispersion liquid to adjust the pH of the dispersion liquid to 5.0. Washing was repeated until the electrical conductivity of a supernatant liquid reached 70 S/cm.

0.98 Molar equivalent of Sr(OH)₂·8H₂O was added to the hydrous titanium oxide. The mixture was loaded into a SUS reaction vessel and purged with a nitrogen gas. Further, distilled water was added so as to achieve 0.5 mol/L in terms of SrTiO₃. The slurry was increased in temperature to 80° C. at 7° C./hour in a nitrogen atmosphere, and was subjected to a reaction for 6 hours after the temperature reached 80° C. After the reaction, the slurry was cooled to room temperature, and the supernatant liquid was removed. After that, the resultant was repeatedly washed with pure water and then filtered through a nutsche. The resultant cake was dried to provide strontium titanate particles (A-1) that had not undergone a sintering step. The physical properties thereof are shown in Table 1.

### <Production of Strontium Titanate Particles (A-2)>

A hydrous titanium oxide slurry obtained by hydrolyzing a titanyl sulfate aqueous solution was washed with an alkali aqueous solution. Next, hydrochloric acid was added to the hydrous titanium oxide slurry to adjust the pH to 0.8. Thus, a titania sol dispersion liquid was obtained. NaOH was added to the titania sol dispersion liquid to adjust the pH of the dispersion liquid to 5.0. Washing was repeated until the electrical conductivity of a supernatant liquid reached 70 S/cm.

0.95 Molar equivalent of Sr(OH)₂·8H₂O was added to the hydrous titanium oxide. The mixture was loaded into a SUS reaction vessel and purged with a nitrogen gas. Further, distilled water was added so as to achieve 0.7 mol/L in terms of SrTiO₃. The slurry was increased in temperature to 65° C. at 8° C./hour in a nitrogen atmosphere, and was subjected to a reaction for 5 hours after the temperature reached 65° C. After the reaction, the slurry was cooled to room temperature, and the supernatant liquid was removed. After that, the resultant was repeatedly washed with pure water and then filtered through a nutsche. The resultant cake was dried to provide strontium titanate particles (A-2) that had not undergone a sintering step. The physical properties thereof are shown in Table 1.

### <Production of Strontium Titanate Particles (A-3)>

Hydrous titanium oxide obtained through hydrolysis by adding ammonia water to a titanium tetrachloride aqueous solution was washed with pure water, and 0.3% sulfuric acid was added to the hydrous titanium oxide slurry in terms of SO₃ with respect to the hydrous titanium oxide. Next, hydrochloric acid was added to the hydrous titanium oxide slurry to adjust the pH to 0.6. Thus, a titania sol dispersion liquid was obtained. NaOH was added to the titania sol dispersion liquid to adjust the pH of the dispersion liquid to 5.0. Washing was repeated until the electrical conductivity of a supernatant liquid reached 50 S/cm.

0.97 Molar equivalent of Sr(OH)₂·8H₂O was added to the hydrous titanium oxide. The mixture was loaded into a SUS reaction vessel and purged with a nitrogen gas. Further, distilled water was added so as to achieve 0.6 mol/L in terms of SrTiO₃. The slurry was increased in temperature to 60° C. at 10° C./hour in a nitrogen atmosphere, and was subjected to a reaction for 7 hours after the temperature reached 60° C. After the reaction, the slurry was cooled to room temperature, and the supernatant liquid was removed. After that, the resultant was repeatedly washed with pure water and then filtered through a nutsche. The resultant cake was dried to provide strontium titanate particles (A-3) that had not undergone a sintering step. The physical properties thereof are shown in Table 1.

### <Production of Strontium Titanate Particles (A-4)>

A hydrous titanium oxide slurry obtained by hydrolyzing a titanyl sulfate aqueous solution was washed with an alkali aqueous solution. Next, hydrochloric acid was added to the hydrous titanium oxide slurry to adjust the pH to 4.0. Thus, a titania sol dispersion liquid was obtained. NaOH was added to the titania sol dispersion liquid to adjust the pH of the dispersion liquid to 8.0. Washing was repeated until the electrical conductivity of a supernatant liquid reached 100 S/cm.

1.02 Molar equivalents of Sr(OH)₂·8H₂O was added to the hydrous titanium oxide. The mixture was loaded into a SUS reaction vessel and purged with a nitrogen gas. Further, distilled water was added so as to achieve 0.3 mol/L in terms of SrTiO₃. The slurry was increased in temperature to 90° C. at 30° C./hour in a nitrogen atmosphere, and was subjected to a reaction for 5 hours after the temperature reached 90° C. After the reaction, the slurry was cooled to room temperature, and the supernatant liquid was removed. After that, the resultant was repeatedly washed with pure water and then filtered through a nutsche. The resultant cake was dried to provide strontium titanate particles (A-4) that had not undergone a sintering step. The physical properties thereof are shown in Table 1.

### <Production of Strontium Titanate Particles (A-5)>

A hydrous titanium oxide slurry obtained by hydrolyzing a titanyl sulfate aqueous solution was washed with an alkali aqueous solution. Next, hydrochloric acid was added to the hydrous titanium oxide slurry to adjust the pH to 4.0. Thus, a titania sol dispersion liquid was obtained. NaOH was added to the titania sol dispersion liquid to adjust the pH of the dispersion liquid to 8.0. Washing was repeated until the electrical conductivity of a supernatant liquid reached 100 S/cm.

1.02 Molar equivalents of Sr(OH)₂·8H₂O was added to the hydrous titanium oxide. The mixture was loaded into a SUS reaction vessel and purged with a nitrogen gas. Further, distilled water was added so as to achieve 0.3 mol/L in terms of SrTiO₃. The slurry was increased in temperature to 90° C. at 30° C./hour in a nitrogen atmosphere, and was subjected to a reaction for 4 hours after the temperature reached 90° C. After the reaction, the slurry was cooled to room temperature, and the supernatant liquid was removed. After that, the resultant was repeatedly washed with pure water and then filtered through a nutsche. The resultant cake was dried to provide strontium titanate particles (A-5) that had not undergone a sintering step. The physical properties thereof are shown in Table 1.

### <Production of Strontium Titanate Particles (A-6)>

A hydrous titanium oxide slurry obtained by hydrolyzing a titanyl sulfate aqueous solution was washed with an alkali aqueous solution. Next, hydrochloric acid was added to the hydrous titanium oxide slurry to adjust the pH to 1.0. Thus, a titania sol dispersion liquid was obtained. NaOH was added to the titania sol dispersion liquid to adjust the pH of the dispersion liquid to 8.0. Washing was repeated until the electrical conductivity of a supernatant liquid reached 90 S/cm.

1.00 Molar equivalent of Sr(OH)₂·8H₂O was added to the hydrous titanium oxide. The mixture was loaded into a SUS reaction vessel and purged with a nitrogen gas. Further, distilled water was added so as to achieve 0.4 mol/L in terms of SrTiO₃. The slurry was increased in temperature to 90° C. at 30° C./hour in a nitrogen atmosphere, and was subjected to a reaction for 5 hours after the temperature reached 90° C. After the reaction, the slurry was cooled to room temperature, and the supernatant liquid was removed. After that, the resultant was repeatedly washed with pure water and then filtered through a nutsche. The resultant cake was dried to provide strontium titanate particles (A-6) that had not undergone a sintering step. The physical properties thereof are shown in Table 1.

### <Production of Strontium Titanate Particles (A-7)>

The strontium titanate particles (A-5) were sintered at 1,000° C., followed by shredding, to provide strontium titanate particles (A-7) each having an irregular particle shape that had undergone a sintering step. The physical properties thereof are shown in Table 1.

### <Production of Strontium Titanate Particles (A-8)>

A hydrous titanium oxide slurry obtained by hydrolyzing a titanyl sulfate aqueous solution was washed with an alkali aqueous solution. Next, hydrochloric acid was added to the hydrous titanium oxide slurry to adjust the pH to 1.0. Thus, a titania sol dispersion liquid was obtained. NaOH was added to the titania sol dispersion liquid to adjust the pH of the dispersion liquid to 8.0. Washing was repeated until the electrical conductivity of a supernatant liquid reached 90 S/cm.

1.00 Molar equivalent of Sr(OH)₂·8H₂O was added to the hydrous titanium oxide. The mixture was loaded into a SUS reaction vessel and purged with a nitrogen gas. Further, distilled water was added so as to achieve 0.4 mol/L in terms of SrTiO₃. The slurry was increased in temperature to 90° C. at 30° C./hour in a nitrogen atmosphere, and was subjected to a reaction for 5 hours after the temperature reached 90° C. After the reaction, the slurry was cooled to room temperature, and the supernatant liquid was removed. After that, the resultant was repeatedly washed with pure water, the slurry containing the precipitate was then adjusted to 50° C., and 6 mol/L hydrochloric acid was added to the slurry to adjust the pH to 2.5. After that, 4.0 mass % of isobutyltrimethoxysilane with respect to the solid content was added, and stirring was continued for 3 hours. A 5 mol/L sodium hydroxide aqueous solution was added to adjust the pH to 8.0, and stirring was continued for 1 hour, followed by filtration and washing. The resultant cake was dried in the atmosphere at 120° C. for 8 hours to provide strontium titanate particles (A-8) that were subjected to surface treatment with isobutyltrimethoxysilane. The physical properties thereof are shown in Table 1.

### <Production of Strontium Titanate Particles (A-9)>

A hydrous titanium oxide slurry obtained by hydrolyzing a titanyl sulfate aqueous solution was washed with an alkali aqueous solution. Next, hydrochloric acid was added to the hydrous titanium oxide slurry to adjust the pH to 0.95. Thus, a titania sol dispersion liquid was obtained. NaOH was added to the titania sol dispersion liquid to adjust the pH of the dispersion liquid to 7.5. Washing was repeated until the electrical conductivity of a supernatant liquid reached 90 S/cm.

1.00 Molar equivalent of Sr(OH)₂·8H₂O was added to the hydrous titanium oxide. The mixture was loaded into a SUS reaction vessel and purged with a nitrogen gas. Further, distilled water was added so as to achieve 0.4 mol/L in terms of SrTiO₃.

The slurry was increased in temperature to 90° C. at 30° C./hour in a nitrogen atmosphere, and was subjected to a reaction for 4.5 hours after the temperature reached 90° C. After the reaction, the slurry was cooled to room temperature, the supernatant liquid was removed. After that, the resultant was repeatedly washed with pure water.

Further, under a nitrogen atmosphere, the above-mentioned slurry was loaded into an aqueous solution obtained by dissolving 6.5 mass % of sodium stearate with respect to the solid content of the slurry, and a zinc sulfate aqueous solution was added dropwise with stirring to deposit zinc stearate on the surface of each of the strontium titanate particles.

The slurry was repeatedly washed with pure water and then filtered through a nutsche. The resultant cake was dried to provide strontium titanate particles (A-9) that were subjected to surface treatment with zinc stearate. The physical properties thereof are shown in Table 1.

### <Production of Titanium Oxide Particles (B-1)>

Ilmenite ore containing 50 mass % of TiO₂ equivalent was used as a starting raw material. This raw material was dried at a temperature of 150° C. for 2 hours, and was then dissolved by adding sulfuric acid. Thus, an aqueous solution of TiOSO₂ was obtained. Sodium carbonate was added to this aqueous solution to adjust the pH to 9.0, to thereby perform alkali neutralization. The neutralized product was filtered to provide a white precipitate. Pure water was added to the white precipitate, and the mixture was subjected to hydrolysis treatment by performing heating treatment for 2 hours while keeping the temperature at about 90° C. The resultant was repeatedly filtered and washed with water to provide anatase-type titanium oxide. The resultant anatase-type titanium oxide was sintered by heating at a high temperature of 1,100° C., to provide rutile-type titanium oxide. The rutile-type titanium oxide was subjected to shredding treatment with a jet mill to provide titanium oxide particles. The titanium oxide particles were dispersed in ethanol. 10 Parts by mass of i-butyltrimethoxysilane serving as a hydrophobizing agent in terms of solid content was mixed dropwise into 100 parts by mass of the titanium oxide particles with sufficient stirring so as to prevent particle coalescence, followed by a reaction to perform hydrophobizing treatment. Further, the pH of the slurry was adjusted to 6.5 with sufficient stirring. The slurry was filtered and dried, and was then subjected to heating treatment at a temperature of 170° C. for 2 hours. After that, the resultant was repeatedly subjected to shredding treatment with a jet mill until titanium oxide aggregates were eliminated. Thus, titanium oxide particles (B-1) were obtained. The physical properties thereof are shown in Table 1.

### <Production of Titanium Oxide Particles (B-2)>

Titanium oxide particles (B-2) were obtained in the same manner as in the production of the titanium oxide particles (B-1) except that the shredding treatment conditions were changed in the jet mill after the sintering in the production of the titanium oxide particles (B-1). The physical properties thereof are shown in Table 1.

TABLE 1

| Strontium | Titanium | Particle | Longest | Shortest | BET specific |
|---|---|---|---|---|---|
| titanate | oxide | diameter | diameter | diameter | surface |
| particles | particles | (nm) | (nm) | (nm) | area (m²/g) |
| A-1 | | 110 | 120 | 100 | 74 |
| A-2 | | 200 | 220 | 180 | 45 |
| A-3 | | 40 | 45 | 35 | 81 |
| A-4 | | 30 | 22 | 18 | 85 |
| A-5 | | 70 | 80 | 60 | 78 |
| A-6 | | 65 | 65 | 65 | 80 |
| A-7 | | 85 | 95 | 75 | 75 |
| A-8 | | 70 | 75 | 65 | 80 |
| A-9 | | 70 | 75 | 65 | 80 |
| | B-1 | 31 | 32 | 30 | 150 |
| | B-2 | 276.5 | 490 | 63 | 8 |

### Production of Toner 1

The following materials were mixed well in a Henschel mixer (“Model FM-75”, manufactured by Mitsui Miike Chemical Engineering Machinery, Co., Ltd.), and were then kneaded in a twin-screw kneader (“Model PCM-30”, manufactured by Ikegai Ironworks Corp) set to a temperature of 130° C. The resultant kneaded product was gradually cooled to room temperature. After that, the resultant was coarsely pulverized with a cutter mill, pulverized with a fine pulverizer using a jet stream, and air-classified to produce “toner base particles” having a weight-average particle diameter of 8.6 μm.

| | | |
|---|---|---|
| Styrene-acrylic resin A: | 100.0 | parts |
| Carbon black (product name: Printex 35; | 7.0 | parts |
| manufactured by Orion Engineered Carbons): | | |
| Synthetic wax (product name: Sasol Spray 30; | 3.0 | parts |
| manufactured by Schumann Sasol, melting point: | | |
| 98° C.): | | |
| Magnetic material: | 4.0 | parts |

The coarsely pulverized product was finely pulverized with a collision type airflow pulverizer using a high-pressure gas. Next, through classification with an air classifier utilizing the Coanda effect, fine powder and coarse powder were simultaneously classified and removed. Thus, “toner base particles” having a weight-average particle diameter of 8.6 m were obtained.

0.4 Part by mass of the strontium titanate particles (A-1) and 1.8 parts by mass of hydrophobic silica particles having an average primary particle diameter of 16 nm, which had been obtained by subjecting fumed silica particles (BET: 200 m²/g) to surface treatment with 20.0 mass % of hexamethyldisilazane, were added to 97.8 parts of the resultant toner base particles, and the materials were mixed with a Henschel mixer (Model FM-75, manufactured by Mitsui Miike Chemical Engineering Machinery, Co., Ltd.) to provide a “toner 1.” The addition amounts thereof are shown in Table 2.

### Production of Toner 2

A “toner 2” was obtained in the same manner as in the production example of the toner 1 except that, in the production example of the toner 1, the amount of the toner base particles was changed to 95.6 parts and the addition amount of the strontium titanate particles (A-2) was changed to 2.6 parts by mass. The addition amounts thereof are shown in Table 2.

### Production of Toner 3

The following materials were mixed well in a Henschel mixer, and then kneaded with a twin-screw kneader set to a temperature of 140° C. The resultant kneaded product was cooled and coarsely pulverized to 1 mm or less with a hammer mill to provide a coarsely pulverized product.

| | | |
|---|---|---|
| Polyester resin A | 110.0 | parts |
| Polyethylene wax (melting point: 97° C.) | 7.0 | parts |
| Metal compound of dialkylsalicylic acid | 1.0 | part |
| Carbon black | 7.0 | parts |
| Magnetic material | 4.0 | parts |

The coarsely pulverized product was finely pulverized with a collision type airflow pulverizer using a high-pressure gas. Next, through classification with an air classifier utilizing the Coanda effect (“ELBOW-JET LABO EJ-L3”, manufactured by Nittetsu Mining Co., Ltd.), fine powder and coarse powder were simultaneously classified and removed. Thus, “toner base particles” having a weight-average particle diameter of 8.6 μm were obtained.

0.4 Part by mass of the strontium titanate particles (A-2) and 1.8 parts by mass of hydrophobic silica particles having an average primary particle diameter of 16 nm, which had been obtained by subjecting fumed silica particles (BET: 200 m²/g) to surface treatment with 20.0 mass % of hexamethyldisilazane, were added to 97.8 parts by mass of the resultant toner base particles, and the materials were mixed with a Henschel mixer to provide a “toner 3.” The addition amounts thereof are shown in Table 2.

### Production of Toner 4

A “toner 4” was obtained in the same manner as in the production example of the toner 3 except that, in the production example of the toner 3, the amount of the polyester resin A was changed to 90.0 parts by mass, the polyester resin B was added in an amount of 20.0 parts by mass, the toner base particles were changed to “toner base particles” having a weight-average particle diameter of 8.4 μm, and the strontium titanate particles were changed to the strontium titanate particles (A-1). The addition amounts thereof are shown in Table 2.

### Production of Toner 5

700 Parts by mass of ion-exchanged water, 1,000 parts by mass of a 0.1 mol/L Na₃PO₄ aqueous solution, and 24.0 parts by mass of a 1.0 mol/L HCl aqueous solution were loaded into a five-necked pressure-resistant vessel including a reflux tube, a stirrer, a temperature gauge, and a nitrogen inlet tube, and the temperature thereof was kept at 63° C. while the mixture was stirred at 12,000 rpm with a high-speed stirring device T.K. HOMOMIXER (manufactured by Tokushu Kika Kogyo Co., Ltd.).

85 Parts by mass of a 1.0 mol/L CaCl₂ aqueous solution was gradually added to the resultant to prepare an aqueous dispersion medium containing a fine water-insoluble dispersion stabilizer Ca₃(PO₄)₂. After that, a toner particle precursor composition was produced through use of the following materials.

| | | |
|---|---|---|
| Polyester resin C: | 60.0 | parts by mass |
| Polyester resin D: | 40.0 | parts by mass |
| Copper phthalocyanine pigment | 6.5 | parts by mass |
| (Pigment Blue 15:3): | | |
| Charge control agent: | 0.5 | part by mass |
| (aluminum compound of 3,5-di-tert-butyl | | |
| salicylic acid) | | |
| Mold release agent (behenyl behenate): | 10.0 | parts by mass |

The above-mentioned materials were dissolved in 400 parts by mass of toluene, and the temperature thereof was increased to 63° C. Thus, a toner particle precursor composition was obtained. Next, the toner particle precursor composition was loaded into the aqueous dispersion medium containing a fine poorly water-soluble dispersion stabilizer Ca₃(PO₄)₂, and granulated for 5 minutes with stirring at 12,000 rpm with a high-speed stirring device. After that, the high-speed stirring device was changed to a propeller-type stirrer, and the internal temperature was increased to 70° C. The time required for the increase in temperature was 10 minutes. Further, a reaction was performed for 5 hours with slow stirring. After that, the temperature was increased to 95° C., and a reaction was performed by heating for 5 hours to provide a slurry of toner particles. After that, the slurry of the toner particles was cooled, and the pH of the system was adjusted to 1.5 or less by adding hydrochloric acid to the slurry of the toner particles, followed by stirring for 1 hour. After that, the resultant was subjected to solid-liquid separation with a pressure filter to provide a toner cake. The toner cake was reslurried with ion-exchanged water to be formed into a dispersion liquid again. After that, the dispersion liquid was subjected to solid-liquid separation with a pressure filter again. The reslurring and the solid-liquid separation were repeated until the electrical conductivity of a filtrate reached 5.0 S/cm or less. After that, finally, the resultant was subjected to solid-liquid separation to provide a toner cake. The resultant toner cake was dried with an airflow dryer Flash Jet Dryer (manufactured by Seishin Enterprise Co., Ltd.), and fine powder and coarse powder were further cut with a multi-division classifier utilizing the Coanda effect. Thus, toner base particles were obtained. Drying conditions were set to a blowing temperature of 90° C. and a dryer outlet temperature of 40° C., and the feed speed of the toner cake was adjusted to a speed at which the outlet temperature did not deviate from 40° C. in accordance with the moisture content of the toner cake. Thus, “toner base particles” having a weight-average particle diameter of 6.2 m were produced.

0.4 Part by mass of the strontium titanate particles (A-1) and 1.8 parts by mass of hydrophobic silica particles having an average primary particle diameter of 16 nm, which had been obtained by subjecting fumed silica particles (BET: 200 m²/g) to surface treatment with 20.0 mass % of hexamethyldisilazane, were added to 97.8 parts of the resultant toner base particles, and the materials were mixed with a Henschel mixer (Model FM-75, manufactured by Mitsui Miike Chemical Engineering Machinery, Co., Ltd.) to provide a “toner 5.” The addition amounts thereof are shown in Table 2.

### Production of Toners 6 to 25

Toners 6 to 25 were each produced in the same manner as in the toner 5 except that, in the production of the toner 5, the addition amount of the silica particles, and the kind and addition amount of strontium titanate or titanium oxide were changed as shown in Table 2. The addition amounts thereof are shown in Table 2.

TABLE 2

| | | | | | Strontium | Titanium | Toner |
|---|---|---|---|---|---|---|---|
| | | | Toner | Silica | titanate | oxide | base |
| | | Titanium | particle | particles | particles | particles | particles |
| | Strontium | oxide | diameter | (part(s) | (part(s) | (part(s) | (part(s) |
| Toner | titanate | particles | (μm) | by mass) | by mass) | by mass) | by mass) |
| 1 | A-1 | | 8.6 | 1.8 | 0.4 | | 97.8 |
| 2 | A-2 | | 8.6 | 1.8 | 2.6 | | 95.6 |
| 3 | A-2 | | 8.6 | 1.8 | 0.4 | | 97.8 |
| 4 | A-1 | | 8.4 | 1.8 | 0.4 | | 97.8 |
| 5 | A-1 | | 6.2 | 1.8 | 0.4 | | 97.8 |
| 6 | A-1 | | 6.2 | 1.8 | 1.2 | | 97 |
| 7 | A-3 | | 6.2 | 1.8 | 1.2 | | 97 |
| 8 | A-4 | | 6.2 | 1.8 | 2 | | 96.2 |
| 9 | A-5 | | 6.2 | 1.8 | 2.5 | | 95.7 |
| 10 | A-6 | | 6.2 | 1.8 | 2.6 | | 95.6 |
| 11 | A-6 | | 6.2 | 1.8 | 1 | | 97.2 |
| 12 | A-6 | | 6.2 | 1.8 | 1.5 | | 96.7 |
| 13 | A-6 | | 6.2 | 1.8 | 0.55 | | 97.65 |
| 14 | A-6 | | 6.2 | 1.8 | 0.6 | | 97.6 |
| 15 | A-7 | | 6.2 | 1.8 | 1.5 | | 96.7 |
| 16 | A-8 | | 6.2 | 1.8 | 1.5 | | 96.7 |
| 17 | A-9 | | 6.2 | 1.8 | 1 | | 97.2 |
| 18 | A-9 | | 6.2 | 1.8 | 1.5 | | 96.7 |
| 19 | A-9 | | 6.2 | 1.8 | 2 | | 96.2 |
| 20 | A-9 | | 6.2 | 2.9 | 1 | | 96.1 |
| 21 | A-9 | | 6.2 | 2.9 | 1.5 | | 95.6 |
| 22 | A-9 | | 6.2 | 2.9 | 0.1 | | 97 |
| 23 | A-9 | | 6.2 | 2.9 | 0.45 | | 96.65 |
| 24 | | B-1 | 6.2 | 2.9 | | 1 | 96.1 |
| 25 | | B-2 | 6.2 | 2.9 | | 1 | 96.1 |

### <Production of Photosensitive Member 1>

### Support:

A cylinder (JIS-A3003, aluminum alloy) formed of an aluminum alloy having an outer diameter of 30 mm, a length of 254 mm, and a thickness of 0.9 mm, whose surface had been roughly cut, was subjected to anodization treatment, and was then subjected to sealing treatment with a sealing agent containing nickel acetate as a main component to form an anodized film (alumite film) having a thickness of about 4.2 μm, to thereby produce a support (conductive support).

### Coating Liquid for Charge-generating Layer:

10 Parts of a Y-form oxytitanium phthalocyanine crystal having a strong peak at a Bragg angle (2θ±0.2°) in CuKα characteristic X-ray diffraction of 27.3° serving as a charge-generating substance, and 150 parts of 4-methoxy-4-methylpentanone-2 were loaded into a sand mill using glass beads each having a diameter of 1 mm, and were subjected to pulverization and dispersion treatment with a sand grind mill for 1.5 hours.

Next, 105 parts of a solution of 5 parts of a polyacetal resin (product name: S-LEC BX-1, manufactured by Sekisui Chemical Co., Ltd.) added and dissolved in 100 parts of 4-methoxy-4-methylpentanone-2 in advance was added, and the resultant mixture was subjected to dispersion treatment for 0.5 hour.

After that, 250 parts of 1,2-dimethoxyethane was added to produce a coating liquid for a charge-generating layer.

The coating liquid for a charge-generating layer was applied onto the resultant support by dip coating, and was dried at 100° C. for 10 minutes so as to have a dry thickness of 0.15 m, to thereby form a charge-generating layer.

The measurement of X-ray diffraction was performed under the following conditions.

Powder of a phthalocyanine compound was pulverized in a mortar until its particle size reached about 10 m while the powder was checked under a microscope. Next, the powder after the pulverization was mounted on the sample filling portion of a reflection-free sample plate in a larger amount, and then the excess powder was scraped off through use of a glass sheet. Thus, a sample plate was prepared so that the measurement surface for X-ray diffraction measurement was flat and the height of the measurement surface was the same as the height of a sample plate reference surface.

### Powder X-Ray Diffraction Measurement

Used measurement apparatus: X-ray diffractometer RINT-TTR II, manufactured by Rigaku Corporation
X-ray tube: Cu
Tube voltage: 50 KV
Tube current: 300 mA
Scanning method: 2θ/θ scan
Scanning speed: 4.0°/min
Sampling interval: 0.02°
Start angle (2θ): 5.0°
Stop angle (2θ): 40.0°
Attachment: standard sample holder
Filter: not used
Incident monochromtor: used
Counter monochromator: not used
Divergence slit: open
Divergence vertical limit slit: 10.00 mm
Scattering slit: open
Receiving slit: open
Plate monochromator: used
Counter: scintillation counter

### Coating Liquid for Charge-Transporting Layer:

10 Parts of a charge-transporting substance (hole-transportable substance) represented by the following structural formula (CTM-1), and 10 parts of a polycarbonate resin having copolymerization units represented by the structural formula (PC-1) and the structural formula (PC-2) (PC-1/PC-2=90/10, Mv=40,000) were dissolved in a mixed solvent of 55 parts of toluene and 45 parts of tetrahydrofuran to produce a coating liquid for a charge-transporting layer.

The coating liquid for a charge-transporting layer was applied onto the resultant charge-generating layer by dip coating, and was dried at 125° C. for 30 minutes so as to have a dry thickness of 17.0 m, to thereby form a charge-transporting layer.

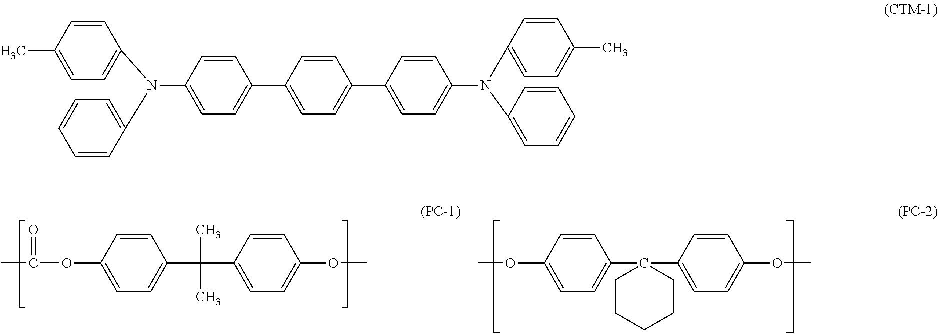

### Coating Liquid for Surface Layer:

The following materials were prepared.

| | | |
|---|---|---|
| Compound represented by the structural formula (OCL-1) | 10 | parts |
| Indium tin oxide particles (product name: indium tin oxide, | 14.7 | parts |
| 30 wt. % dispersion liquid in isopropanol (manufactured | | |
| by Sigma-Aldrich)) | | |
| Siloxane-modified acrylic compound (product name: | 0.2 | part |
| BYK-3550, manufactured by BYK Japan KK) | | |

Those materials were mixed with a mixed solvent of 72 parts of 2-propanol and 8 parts of tetrahydrofuran, and the mixture was stirred. Thus, a coating liquid 1 for a surface layer was prepared.

The coating liquid 1 for a surface layer was applied onto the resultant charge-transporting layer by dip coating to form a coat so that its dry thickness was 3.0 m, and the resultant coat was dried at 50° C. for 6 minutes. After that, through use of an electrodeless lamp H bulb (manufactured by Heraeus), the coat was irradiated with UV light for 10 seconds under the condition of a lamp intensity of 0.6 W/cm² while the support (object to be irradiated) was rotated at a speed of 300 Rpm. Next, the coat was naturally cooled until its temperature became 25° C., and then the coat was subjected to heating treatment for 1 hour under such a condition that its temperature became 125° C., to thereby form a surface layer having a thickness of 3 μm. Thus, a photosensitive member 1 was produced.

### <Production of Photosensitive Member 2>

The following materials were prepared.

| | | |
|---|---|---|
| Compound represented by the structural formula (OCL-2) | 10 | parts |
| Indium tin oxide particles (product name: High BET | 14.7 | parts |
| type, manufactured by TOMOE Engineering Co., Ltd.) | | |
| (dispersion liquid of indium tin oxide particles | | |
| produced in advance through use of the particles): | | |
| Siloxane-modified acrylic compound (product name: | 0.2 | part |
| BYK-3550, manufactured by BYK Japan KK) | | |

As the dispersion liquid of indium tin oxide particles, a dispersion liquid obtained by producing a 30 wt % 2-propanol solution of indium tin oxide particles and dispersing the particles with ultrasonic waves for 2 hours was used.

Those materials were mixed with a mixed solvent of 72 parts of 2-propanol and 8 parts of tetrahydrofuran, and the mixture was stirred. A photosensitive member 2 was obtained in the same manner as in the photosensitive member 1 except that a coating liquid 2 for a surface layer was prepared as described above.

### <Production of Photosensitive Member 3>

The following materials were prepared.

| | | |
|---|---|---|
| Compound represented by the structural formula (OCL-3) | 10 | parts |
| Indium tin oxide particles (product name: | 14.7 | parts |
| nanopowder, <50 nm particle size, manufactured by | | |
| Sigma-Aldrich) (dispersion liquid of indium tin oxide | | |
| particles produced in advance through use of the | | |
| particles) | | |
| Siloxane-modified acrylic compound (product name: | 0.2 | part |
| BYK-3550, manufactured by BYK Japan KK) | | |

As the dispersion liquid of indium tin oxide particles, a dispersion liquid obtained by producing a 30 wt % 2-propanol solution of indium tin oxide particles and dispersing the particles with ultrasonic waves for 2 hours was used.

Those materials were mixed with a mixed solvent of 72 parts of 2-propanol and 8 parts of tetrahydrofuran, and the mixture was stirred. A photosensitive member 3 was obtained in the same manner as in the photosensitive member 1 except that a coating liquid 3 for a surface layer was prepared as described above.

### <Production of Photosensitive Members 4 to 14>

Photosensitive members 4 to 14 were each produced in the same manner as in the photosensitive member 1 except that, in the coating liquid 1 for a surface layer, the contents of the compounds and the indium tin oxide particles were changed to those shown in Table 3 to produce a coating liquid.

### <Production of Photosensitive Member 15>

The following materials were prepared.

| | | |
|---|---|---|
| Compound represented by the structural formula (OCL-4) | 10 | parts |
| Titanium oxide particles (product name: MT-500SA, | 14.7 | parts |
| manufactured by TAYCA Co., Ltd.) (dispersion liquid of | | |
| titanium oxide particles produced in advance through use | | |
| of the particles) | | |
| Siloxane-modified acrylic compound (product name: | 0.2 | part |
| BYK-3550, manufactured by BYK Japan KK) | | |

In place of the dispersion liquid of indium tin oxide particles, a dispersion liquid obtained by producing a 30 wt % 2-propanol solution of titanium oxide particles and dispersing the particles with ultrasonic waves for 2 hours was used. Those materials were mixed with a mixed solvent of 72 parts of 2-propanol and 8 parts of tetrahydrofuran, and the mixture was stirred. A photosensitive member 15 was produced in the same manner as in the photosensitive member 1 except that a coating liquid 15 for a surface layer was prepared as described above.

TABLE 3

| | | | | Addition | | | | |
|---|---|---|---|---|---|---|---|---|
| | | Content | Content of | amount of | | Diameter | | |
| | | of indium | titanium | dispersion | | of indium | Titanium | |
| | | tin oxide | oxide | liquid | Number of | tin oxide | oxide | |
| Photosensitive | Coating liquid for | particles | particles | (part(s) by | protrusions/ | particle | particles | OC |
| member | surface layer | (%) | (%) | mass) | piece(s) | (nm) | (nm) | monomer |
| Photosensitive | Coating liquid 1 | 30 | | 14.7 | 5 | 70 | | OCL-1 |
| member 1 | for surface layer | | | | | | | |
| Photosensitive | Coating liquid 2 | 30 | | 14.7 | 5 | 75 | | OCL-2 |
| member 2 | for surface layer | | | | | | | |
| Photosensitive | Coating liquid 3 | 30 | | 14.7 | 5 | 40 | | OCL-3 |
| member 3 | for surface layer | | | | | | | |
| Photosensitive | Coating liquid 4 | 20 | | 8.5 | 3 | 70 | | OCL-5 |
| member 4 | for surface layer | | | | | | | |
| Photosensitive | Coating liquid 5 | 20 | | 8.5 | 3 | 70 | | OCL-4 |
| member 5 | for surface layer | | | | | | | |
| Photosensitive | Coating liquid 6 | 10 | | 3.8 | 2 | 70 | | OCL-4 |
| member 6 | for surface layer | | | | | | | |
| Photosensitive | Coating liquid 7 | 5 | | 1.8 | 1 | 70 | | OCL-4 |
| member 7 | for surface layer | | | | | | | |
| Photosensitive | Coating liquid 8 | 5 | | 1.8 | 1 | 70 | | OCL-6 |
| member 8 | for surface layer | | | | | | | |
| Photosensitive | Coating liquid 9 | 4 | | 1.4 | 1 | 70 | | OCL-4 |
| member 9 | for surface layer | | | | | | | |
| Photosensitive | Coating liquid 10 | 32 | | 16.0 | 5 | 70 | | OCL-4 |
| member 10 | for surface layer | | | | | | | |
| Photosensitive | Coating liquid 11 | 5 | | 1.8 | 1 | 70 | | OCL-5 |
| member 11 | for surface layer | | | | | | | |
| Photosensitive | Coating liquid 12 | 30 | | 14.7 | 5 | 70 | | OCL-8 |
| member 12 | for surface layer | | | | | | | |
| Photosensitive | Coating liquid 13 | 20 | | 8.5 | 3 | 70 | | OCL-7 |
| member 13 | for surface layer | | | | | | | |
| Photosensitive | Coating liquid 14 | 20 | | 8.5 | 3 | 70 | | OCL-9 |
| member 14 | for surface layer | | | | | | | |
| Photosensitive | Coating liquid 15 | | 30 | 14.7 | 3 | | 35 | OCL-4 |
| member 15 | for surface layer | | | | | | | |

<Mounting onto Image Forming Apparatus>

### Examples 1 to 31 and Comparative Examples 1 to 3

Mounting onto an electrophotographic apparatus was performed in each of the combinations shown in Tables 4-1 and 4-2.

Specifically, a reconstructed machine of a laser beam printer, (product name: MS812, manufactured by Lexmark) was used as the electrophotographic apparatus. The electrophotographic apparatus used for evaluation was reconstructed so as to be capable of adjusting and measuring an image exposure amount, the amount of a current flowing from a charging roller to the support of the electrophotographic photosensitive member (hereinafter sometimes referred to as “total current”), and a voltage applied to the charging roller.

### <Image Smearing Evaluation Method>

The occurrence of image smearing was evaluated under the following conditions with the electrophotographic apparatus mounted with any one of Examples 1 to 31 and Comparative Examples 1 to 3.

The electrophotographic apparatus mounted with the electrophotographic photosensitive member and the toner was left to stand under an environment having a temperature of 32° C. and a relative humidity 80% for 24 hours or more.

Image output of a test chart having a print percentage of 1% was continuously performed on 100,000 sheets of letter-size plain paper. The image output of the test chart was performed by repeating continuous output on 100 sheets and a pause in output of 2 seconds.

After endurance of the 100,000 sheets, the main power source of the image forming apparatus was turned off, and the main power source was turned on 12 hours after the main power was turned off. Immediately, a halftone image (relative reflection density of 0.4 on a Macbeth densitometer) and a 6-dot lattice image on an entire surface were printed onto 30 sheets. The states of the printed images were visually observed and evaluated based on the following evaluation criteria.

### (Evaluation Criteria)

0: No image smearing occurs in the halftone image or the lattice image on the first sheet.
1: A faint band-shaped density reduction is recognized only in the halftone images in the longitudinal direction of the photosensitive member, but no image smearing occurs on the second and subsequent sheets.
2: A faint band-shaped density reduction is recognized only in the halftone images in the longitudinal direction of the photosensitive member, but no image smearing occurs on the third and subsequent sheets.
3: A faint band-shaped density reduction is recognized only in the halftone images in the longitudinal direction of the photosensitive member, but no image smearing occurs on the fourth and subsequent sheets.
4: A faint band-shaped density reduction is recognized only in the halftone images in the longitudinal direction of the photosensitive member, but no image smearing occurs on the fifth and subsequent sheets.
5: A faint band-shaped density reduction is recognized both in the halftone images and the lattice images, but no image smearing occurs on the fifth and subsequent sheets.
6: A clear density reduction is recognized both in the halftone images and the lattice images, but no image smearing occurs on the tenth and subsequent sheets.
7: A clear density reduction is recognized both in the halftone images and the lattice images, but no image smearing occurs on the fifteenth and subsequent sheets.
8: A clear density reduction is recognized both in the halftone images and the lattice images, but no image smearing occurs on the twentieth and subsequent sheets.
9: A clear density reduction is recognized both in the halftone images and the lattice images, but no image smearing occurs on the twenty-fifth and subsequent sheets.
10: A clear density reduction is recognized both in the halftone images and the lattice images, but no image smearing occurs on the thirtieth and subsequent sheets.
11: A clear density reduction is recognized both in the halftone images and the lattice images, and image smearing occurs even on the thirtieth sheet.

The results are shown in Tables 4-1 and 4-2.

TABLE 4-1

| | | | External additive for toner | |
|---|---|---|---|---|
| | Photo- | | Content of | Content of |
| | sensitive | | strontium titanate | titanium oxide |
| Example | member | Toner | particles A (%) | particles (%) |
| Example 1 | 1 | 1 | 0.4 | |
| Example 2 | 2 | 2 | 2.6 | |
| Example 3 | 3 | 2 | 2.6 | |
| Example 4 | 4 | 3 | 0.4 | |
| Example 5 | 4 | 4 | 0.4 | |
| Example 6 | 4 | 5 | 0.4 | |
| Example 7 | 5 | 6 | 1.2 | |
| Example 8 | 6 | 6 | 1.2 | |
| Example 9 | 7 | 7 | 1.2 | |
| Example 10 | 7 | 8 | 2 | |
| Example 11 | 8 | 9 | 2.5 | |
| Example 12 | 9 | 10 | 2.6 | |
| Example 13 | 10 | 11 | 1 | |
| Example 14 | 5 | 11 | 1 | |
| Example 15 | 5 | 12 | 1.5 | |
| Example 16 | 5 | 13 | 0.55 | |
| Example 17 | 5 | 14 | 0.6 | |
| Example 18 | 5 | 15 | 1.5 | |
| Example 19 | 5 | 16 | 1.5 | |
| Example 20 | 5 | 17 | 1 | |
| Example 21 | 5 | 18 | 1.5 | |
| Example 22 | 5 | 19 | 2 | |
| Example 23 | 5 | 20 | 1 | |
| Example 24 | 5 | 21 | 1.5 | |
| Example 25 | 11 | 22 | 0.1 | |
| Example 26 | 12 | 22 | 0.1 | |
| Example 27 | 8 | 23 | 0.45 | |
| Example 28 | 12 | 23 | 0.45 | |
| Example 29 | 13 | 20 | 1 | |
| Example 30 | 14 | 20 | 1 | |
| Example 31 | 1 | 2 | 2.6 | |
| Comparative | 5 | 24 | | 1 |
| Example 1 | | | | |
| Comparative | 5 | 25 | | 1 |
| Example 2 | | | | |
| Comparative | 15 | 20 | 1 | |
| Example 3 | | | | |

TABLE 4-2

| | Particles in surface of | | | | | |
|---|---|---|---|---|---|---|
| | photosensitive member | | | ESCA - | | |
| | Content of | Content of | | C(═O)O | Rank of | Abrasion |
| | indium tin oxide | titanium oxide | | group area | image | resistance |
| Example | particles B (%) | particles (%) | B/A | (%) | smearing | (μm/K) |
| Example 1 | 30 | | 75.0 | 6 | 3 | 0.013 |
| Example 2 | 30 | | 11.5 | 6 | 2 | 0.013 |
| Example 3 | 30 | | 11.5 | 6 | 2 | 0.011 |
| Example 4 | 20 | | 50.0 | 4 | 3 | 0.013 |
| Example 5 | 20 | | 50.0 | 3 | 3 | 0.017 |
| Example 6 | 20 | | 50.0 | 3 | 3 | 0.012 |
| Example 7 | 20 | | 16.7 | 3 | 0 | 0.012 |
| Example 8 | 10 | | 8.3 | 3 | 0 | 0.012 |
| Example 9 | 5 | | 4.2 | 3 | 0 | 0.012 |
| Example 10 | 5 | | 2.5 | 3 | 0 | 0.012 |
| Example 11 | 5 | | 2.0 | 3 | 1 | 0.012 |
| Example 12 | 4 | | 1.5 | 3 | 2 | 0.012 |
| Example 13 | 32 | | 32.0 | 3 | 0 | 0.013 |
| Example 14 | 20 | | 20.0 | 3 | 0 | 0.012 |
| Example 15 | 20 | | 13.3 | 3 | 0 | 0.012 |
| Example 16 | 20 | | 36.4 | 3 | 1 | 0.012 |
| Example 17 | 20 | | 33.3 | 3 | 0 | 0.012 |
| Example 18 | 20 | | 13.3 | 3 | 0 | 0.012 |
| Example 19 | 20 | | 13.3 | 3 | 0 | 0.012 |
| Example 20 | 20 | | 20.0 | 3 | 0 | 0.012 |
| Example 21 | 20 | | 13.3 | 3 | 0 | 0.012 |
| Example 22 | 20 | | 10.0 | 3 | 0 | 0.012 |
| Example 23 | 20 | | 20.0 | 3 | 0 | 0.012 |
| Example 24 | 20 | | 13.3 | 3 | 0 | 0.012 |
| Example 25 | 5 | | 50.0 | 3 | 3 | 0.012 |
| Example 26 | 30 | | 300.0 | 3 | 3 | 0.013 |
| Example 27 | 5 | | 11.1 | 3 | 2 | 0.012 |
| Example 28 | 30 | | 66.7 | 3 | 3 | 0.013 |
| Example 29 | 20 | | 20.0 | 3 | 0 | 0.012 |
| Example 30 | 20 | | 20.0 | 3 | 0 | 0.012 |
| Example 31 | 30 | | 11.5 | 7 | 2 | 0.013 |
| Comparative | 20 | | 20.0 | 18 | 9 | 0.012 |
| Example 1 | | | | | | |
| Comparative | 20 | | 20.0 | 16 | 9 | 0.020 |
| Example 2 | | | | | | |
| Comparative | | 30 | 0.0 | 18 | 9 | 0.025 |
| Example 3 | | | | | | |

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-054287, filed Mar. 28, 2024, and Japanese Patent Application No. 2025-003592, filed Jan. 9, 2025, which are hereby incorporated by reference herein in their entirety.

What is claimed is:

1. An electrophotographic apparatus comprising:
an electrophotographic photosensitive member;
a charging unit configured to charge a surface of the electrophotographic photosensitive member;
an image exposing unit configured to irradiate the charged surface of the electrophotographic photosensitive member with image exposure light to form an electrostatic latent image on the surface of the electrophotographic photosensitive member;
a developing unit, which includes a toner, and which is configured to develop the electrostatic latent image formed on the surface of the electrophotographic photosensitive member with the toner to form a toner image on the surface of the electrophotographic photosensitive member; and
a transferring unit configured to transfer the toner image formed on the surface of the electrophotographic photosensitive member onto a transfer material,
wherein the electrophotographic photosensitive member includes a surface layer containing indium tin oxide particles and a (meth)acrylic resin, and
wherein the toner contains strontium titanate particles as an external additive.

2. The electrophotographic apparatus according to claim 1, wherein, when a ratio of a mass of the strontium titanate particles serving as the external additive to a total mass of the toner is represented by A (mass %), the A is 0.5 mass % or more and 2.5 mass % or less.

3. The electrophotographic apparatus according to claim 1,
wherein, when a ratio of a mass of the strontium titanate particles serving as the external additive to a total mass of the toner is represented by A (mass %), and a ratio of a mass of the indium tin oxide particles to a total mass of the surface layer is represented by B (mass %), a ratio B/A of the B (mass %) to the A (mass %) is 2.5 or more and 35.0 or less.

4. The electrophotographic apparatus according to claim 1, wherein the strontium titanate particles each have a BET specific surface area of 70 m²/g or more and 110 m²/g or less.

5. An electrophotographic process cartridge comprising:
an electrophotographic photosensitive member;
a charging unit configured to charge a surface of the electrophotographic photosensitive member;
an image exposing unit configured to irradiate the charged surface of the electrophotographic photosensitive member with image exposure light to form an electrostatic latent image on the surface of the electrophotographic photosensitive member; and
a developing unit, which includes a toner, and which is configured to develop the electrostatic latent image formed on the surface of the electrophotographic photosensitive member with the toner to form a toner image on the surface of the electrophotographic photosensitive member,
wherein the electrophotographic photosensitive member includes a surface layer containing indium tin oxide particles and a (meth)acrylic resin, and
wherein the toner contains strontium titanate particles as an external additive.

6. The electrophotographic process cartridge according to claim 5, wherein, when a ratio of a mass of the strontium titanate particles serving as the external additive to a total mass of the toner is represented by A (mass %), the A is 0.5 mass % or more and 2.5 mass % or less.

7. The electrophotographic process cartridge according to claim 5, wherein, when a ratio of a mass of the strontium titanate particles serving as the external additive to a total mass of the toner is represented by A (mass %), and a ratio of a mass of the indium tin oxide particles to a total mass of the surface layer is represented by B (mass %), a ratio B/A of the B (mass %) to the A (mass %) is 2.5 or more and 35.0 or less.

8. The electrophotographic process cartridge according to claim 5, wherein the strontium titanate particles each have a BET specific surface area of 70 m²/g or more and 110 m²/g or less.
